(19) United States
(12) Patent Application Publication
(10) Pub. No.: US 2016/0035233 A1
(43) Pub. Date: Feb. 4, 2016

(54) Secure Testing System and Method

(71) Applicant: David B. Breed, Miami Beach, FL (US)

(72) Inventor: David B. Breed, Miami Beach, FL (US)

(21) Appl. No.: 14/448,598

(22) Filed: Jul. 31, 2014

(51) Int. Cl. G09B 7/00; G06F 21/88; G01R 27/26; G06F 21/86; G02B 27/01; H04R 1/02

(52) U.S. Cl. CPC G09B 7/00; G02B 27/017; H04R 1/028; G01R 27/2605; G06F 21/86; G06F 21/88; G02B 2027/0178; H04R 2499/15

(57) ABSTRACT

Headpiece includes a frame having a support portion adapted to be supported on a person's head and a viewable portion adapted to present visual data to the person when said support portion is supported on the person's head. A camera obtains images of an environment around the person. A user interface receives input from the person. A processor controls content of the viewable portion based on input received via the user interface. A communication-detecting sensor detects communications. The processor monitors detection of communications detected by the communication-detecting sensor and images obtained by the imaging device when the viewable portion is displaying a test to determine whether a person other than the person on which the support portion is supported is present or providing information to the person on which the support portion is supported.

### BACKGROUND OF THE INVENTION

1. Technical Field

The present disclosure relates to the field of a computer-based system and method for taking a test while ensuring that the test-taker is not receiving assistance from another person while taking the test and that the device being used for displaying or taking the test has not been and is not being tampered with or otherwise compromised.

2. Description of the Related Art

There has been a great deal of discussion in the press over the past several years relating to MOOCs, Massive Open Online Courses. Through the use of the Internet, education can be freely distributed to anyone who has Internet access. It is now generally recognized that mastery of almost any field taught in colleges and universities can be achieved by a motivated student without actually attending lectures at that college or university. Thus, the technology is in place for a student to obtain the knowledge that has previously only been available to a campus-resident, matriculated student at a college, university or other institution at virtually no cost.

In contrast, the cost of a traditional Massachusetts Institute of Technology (MIT) education, for example, resulting in a bachelor's degree can exceed one hundred thousand dollars. The only impediment which exists from preventing a university such as MIT from granting a degree to such a student is that the university needs to know with absolute certainty that the student did not cheat when taking the various exams required to demonstrate mastery of the coursework. With a degree from MIT, for example, industry will hire such a person at a starting salary approaching or exceeding $100,000 per year. Thus, the value to the student is enormous. Since the information which must be mastered is now available for free on the Internet, the only impediment separating a motivated student from a high starting salary is that a degree-granting university must be certain that the student has demonstrated his mastery of the material through successful completion of examinations.

U.S. Pat. No. 5,565,316 (Kershaw et al.) describes a system and method for computer-based testing. The system comprises a test development system for producing a computerized test, a test delivery system for delivering the computerized test to an examinee, and a workstation on which the computerized test is delivered to the examinee. The method comprises producing a computerized test, delivering the computerized test to an examinee and recording examinee responses to questions presented to the examinee during the delivery of the computerized test. A method of delivering a computerized test is also provided in which a standardized test is created, an electronic form of the test is then prepared, the items of the test are presented to an examinee on a workstation display and the examinee's responses are accepted and recorded. A method of administering a computerized test is further provided in which a computerized test is installed on a workstation and then the delivery of the test to an examinee is initiated.

U.S. Pat. No. 5,915,973 (Hoehn-Saric et al.) describes a system for controlling administration of remotely proctored, secure examinations at a remote test station, and a method for administering examinations. The system includes a central station, a registration station and a remote testing station. The central station includes (a) storage device for storing data, including test question data and verified biometric data, and (b) a data processor, operably connected to the storage device, for comparing test-taker biometric data with stored, verified biometric data. The remote test station includes (a) a data processor, (b) a data storage device, operably connected to the data processor, for storing input data, (c) a biometric measurement device for inputting test-taker biometric data to the processor, (d) a display for displaying test question data, (e) an input for inputting test response data to the processor, (f) a recorder for recording proctoring data of a testing event, and (g) a communication link for communicating with the central station, for receiving test question data from the central station, and for communicating test-taker biometric data, test response data, and proctoring data to the central station. Verification of the test-taker and validation of the results can be performed either before or after the testing event.

U.S. Pat. No. 5,947,747 (Walker et al.) describes methods and apparatus for computer-based evaluation of a test-taker's performance with respect to selected comparative norms. The system includes a home testing computer for transmitting the test-taker's test results to a central computer which derives a performance assessment of the test-taker. The performance assessment can be standardized or customized, as well as relative or absolute. Further, the transmitted test results are configured to reliably associate the student with his test results, using encoding, user identification, or corroborative techniques to deter fraud. Thus, for example, the system allows a parentally-controlled reward system such that children who reach specified objectives can claim an award that parents are confident was fairly and honestly earned without the parent being required to proctor the testing. Fraud, and the need for proctoring, is also deterred during multiple students testing via an option for simultaneous testing of geographically dispersed test-takers.

U.S. Pat. No. 7,069,586 (Winneg et al.) describes a method of and system for securely executing an application on a computer system such that a user of the computer system cannot access or view unauthorized content available on the computer system or accessible using the computer system. To securely execute the application, such method and system may terminate any unauthorized processes executing (i.e., running) on the computer system application prior to execution of the application, and may configure the application such that unauthorized content cannot be accessed, including configuring the application such that unauthorized processes cannot be initiated (i.e., launched) by the application. Further, such system and method may terminate any unauthorized processes detected during execution of the application, and may disable any functions of the computer system that are capable of accessing unauthorized content, including disabling any functions capable of initiating processes on the computer system. The application being securely executed may be any of a variety of types of applications, for example, an application for receiving answers to questions of an examination (i.e., an exam-taking application). Securely executing an application may be used for any of a variety of purposes, including, among other purposes, to assist preventing students from cheating on exams, to assist preventing students from not paying attention in class, to assist preventing employees from wasting time at work, and to assist preventing children from viewing content that their parents deem inappropriate.

U.S. Pat. No. 7,257,557 (Hulick) describes a method, program and system for administering tests in a distributed data processing network in which predetermined test content and multimedia support material are combined into a single encrypted test file. The multimedia support may include visual and audio files for presenting test questions. The encrypted test file is exported to at least one remote test location. The test locations import and decrypt the encrypted test file and load the test content and multimedia support material into a local database. The test is administered on a plurality of client workstations at the testing location, wherein the test may include audio questions and verbal responses by participants. During the course of testing, biometric data about test participants is recorded and associated with the test files and participant identification. After the test is completed, the completed test results, including verbal responses and biometric data, are combined into a single encrypted results file that is exported to a remote evaluation location. The evaluation location imports and decrypts the encrypted results file and loads the test results into a local database for grading.

U.S. Pat. Appln. Publ. No. 2007/0117083 (Winneg et al.) describes systems, methods and apparatuses for remotely monitoring examinations. Examinations are authored and rules are attributed to the exams that determine how the exams are to be administered. Exam proctors monitor exam takers from remote locations by receiving data indicative of the environment in which the exam takers are completing the exams. A remote exam monitoring device captures video, audio and/or authentication data and transmits the data to a remote proctor and data analysis system.

As generally used herein, a “test” is any type of question-based application that requires analysis by a person taking the test and a response from this person. A test may therefore be considered an examination, a quiz, an assessment, an evaluation, a trial and/or an analysis.

As generally used herein, a “laptop computer” is a portable computing device that includes hardware and software for conventional functionality for outputting questions (visually and/or audibly) and receiving via one or more user interfaces, responses to the questions. A laptop computer is an example of a preferred implementation of the disclosure but the disclosure may also be implemented in other types of computers, e.g., desktops, tablets, notebooks, notepads, and the like.

### SUMMARY OF THE INVENTION

The present disclosure is directed at solving the problem of guaranteeing with a high degree of certainty that a student taking a test is acting alone without the aid of a consultant or otherwise cheating.

An arrangement for test taking for use with a computer includes a head wearable device which includes at least one sound sensor for detecting sound, at least one optical imaging device that obtains images of an area viewed by the student, and a display which is only viewable by the test-taker. A processing unit is coupled to the sensor(s) and imaging device(s) and receives and analyzes data therefrom to determine whether the test-taker is interacting with another person and/or whether the test-taker is receiving communications from another person.

A headpiece in accordance with the invention includes a frame having a support portion adapted to be supported on a person's head and a viewable portion adapted to present visual data to the person when the support portion is supported on the person's head. This headpiece may be of the type to which GOOGLE GLASS™ is an example of. At least one imaging device is arranged on the frame or an accompanying strap that overlies the person's head and obtains images of an environment around the person when the support portion is supported on the person's head. At least one user interface is arranged on the frame or strap to receive input from the person when the support portion is supported on the person's head. A processor is arranged on the frame and coupled to the at least one user interface and the viewable portion. The processor is configured to control content of the viewable portion based on input received via the at least one user interface. At least one communication-detecting sensor on the frame or strap detects communications. The processor monitors detection of communications detected by the at least one communication-detecting sensor and images obtained by the at least one imaging device when the viewable portion is displaying a test to determine whether a person other than the person on which the support portion is supported is present or providing information to the person on which the support portion is supported. The user interface may include a sound-detecting sensor, in which case, the processor monitors detection of sound by the sound-detecting sensor when the viewable portion is displaying a test.

A method for detecting an attempt to physically alter an electronic device in accordance with the invention is a type of chassis intrusion detector. In the method, the device is enclosed within two closely spaced conductive films overlying one another to define an envelope, capacitance between the films is periodically measured by means of a security assembly coupled to the films, and the measured capacitance is monitored by means of the security assembly to determine changes in capacitance, changes in capacitance being correlated to an attempt to alter the device, i.e., detection of possible intrusion into the chassis of the device. In a preferred embodiment, the device is a laptop being used for test-taking and thus with the method incorporated into the device, secure test taking is provided.

The security assembly includes a processor, a power source for providing power to the processor and a RAM assembly containing a required security code for use of the device for test-taking purposes. The security assembly is configured such that any attempt to disassemble the security assembly will break one or more wires connecting the power source to the processor and such that a change in capacitance relative to a threshold will cause the security code to be erased from the RAM assembly. The security assembly is coupled to the device using a port of the device and with the security assembly within the films. Apertures are provided in the envelope defined by the films in which the device is placed, the apertures having a size and location aligning with power and USB ports of the device. The films are transparent at portions that overlie a display of the device.

An intrusion-protected electronic device in accordance with the invention includes an envelope defined by two closely spaced conductive films overlying one another that enclose the device, and a security assembly coupled to the films and that periodically measures capacitance between the films. The security assembly is configured to monitor the measured capacitance to determine changes in capacitance, changes in capacitance being correlated to an attempt to alter the device.

A method for limiting viewing of content on a display includes changing images being displayed on the display at a high rate at which viewing the display does not provide a discernible image to a viewer, equipping a person with a viewing device having lenses that are selectively opaque or transparent, and controlling the lenses to cause the lenses to be transparent only when determined content, e.g., a test, is being displayed on the display to enable only a lenses-equipped person to correctly view the predetermined content. The image frames containing the predetermined content are preferably randomized and an indication of the randomization provided only to the viewing device. The viewing device preferably incorporates a chassis intrusion detection system.

### BRIEF DESCRIPTION OF THE DRAWINGS

The following drawings are illustrative of embodiments of the system developed or adapted using the teachings of at least one of the embodiments disclosed herein and are not meant to limit the scope of the disclosure as encompassed by the claims.

FIG. 1 illustrates a room with a test-taker showing a laptop computer which has been prepared using the teachings of this disclosure.

FIG. 1A illustrates a room with a test-taker showing a camera lens and a projector projecting through a wall behind the student to facilitate cheating.

FIGS. 2A, 2B, and 2C are schematic diagrams of special arrangements that can be used to implement the disclosure.

FIG. 3 is a flowchart illustrating a startup, running, and shut down of the test taking process.

FIG. 4 illustrates a flowchart for the encryption scheme utilized to prevent access to the test by other computers or devices then the designated laptop computer.

FIG. 5 is a pattern recognition flowchart using neural networks for identifying the test taker.

FIG. 6 is a schematic view of a tower for placement in proximity to a computer used for test taking.

FIG. 7 is an outline of a fisheye lens for use with the tower shown in FIG. 6.

FIG. 8 is an outline of a dual camera assembly for use with the tower shown in FIG. 6.

FIG. 9 is a view of a transducer board for the tower shown in FIG. 6.

FIG. 10 is a view of a processor board for the tower shown in FIG. 6.

FIG. 11 is a side view of the boards shown in FIGS. 9 and 10 connected together.

FIG. 12 is a schematic showing a test-taking arrangement with a head-mounted apparatus.

FIG. 13A illustrates the arrangement where the tablet is mounted on ledge of the tower.

FIG. 13B illustrated the case of FIG. 13A only with the tower and the tablet separated.

FIG. 14 is a similar illustration to FIG. 12 but with use of display glasses similar to Google Glass.

FIG. 15 is a view where the spherical camera is separated into two camera halves to eliminate the low resolution band.

FIG. 16A illustrates the addition of a chassis Intrusion detector system using transparent conductive films encapsulating the entire tablet computer, FIG. 16B illustrates the case where the film encapsulation film in inside of the housing and FIG. 16C illustrates the case where a matrix of thin printed wires replaces the conductive films of FIGS. 16A and 16B.

FIG. 17 is a schematic of the operation of the chassis intrusion detector of FIG. 16C.

FIG. 18 illustrates the use of liquid crystal glasses which are sequenced with the display to allow the student to see the test but not an observer of the tablet display.

### DETAILED DESCRIPTION OF THE INVENTION

A primary concept of the present disclosure is that a student located anywhere in the world ought to be able to obtain the equivalent of a degree from any college or university, providing that the student can prove that he or she has mastered the coursework. This proof naturally must come from the student passing a series of examinations. Since the student can be located anywhere in the world, it can be impractical for that student to travel to a particular place in order to take an examination.

Hiring organizations basically do not care where the person has acquired the expertise as long as they can be confident that the student has done so. As an employer, for example, a manager does not care as much whether a person graduated from Harvard or MIT but he does care in particular whether the prospective employee has mastered the coursework. On the other hand, having a degree listed on a person's resume can greatly affect the person's opportunities for employment throughout his or her lifetime. In the United States, however, colleges and universities have become unreasonably expensive especially when consideration is given to the fact that for the most prestigious schools, the student usually is required to reside on or near the campus. This residency requirement has little to do with his or her mastery of physics, engineering or other scientific or non-scientific subjects, but handicaps an otherwise qualified student from job opportunities.

A student can typically learn the coursework on his or her own and in fact, studies have shown that for many students attending class is largely a waste of time. Over the Internet, a student can be exposed to the very best teachers, textbooks and other coursework. If this is done with a large number of students, the cost per student is minimal. What is needed, however, is a method of verifying that a particular student has mastered the subject matter through taking and passing a particular examination over the Internet and without cheating.

An objective of the present disclosure is therefore to provide a system that is capable of ascertaining the identity of a test-taker with certainty and that cheating has not occurred during test taking. Prior to discussing how these goals are achieved an understanding of the cheating prevention process needs to begin with an analysis of the flow of information from the test providing institution to the student's eyes.

For now assume that the test is a multiple choice test or one where the answer is in the form of a number. The institution can randomize the questions on a particular test so that no student will take the same test with the order of the questions the same. Therefore, knowing the answers provided by one student cannot help another student. As a result, the answers which are sent back to the institution do not need to be encrypted.

The questions making up the test however do need to be encrypted and careful attention needs to be paid to where the decryption process occurs and to the protection of the private key which performs the decryption. For example, if the decryption occurs in an unprotected computer, then two problems arise. First, the decrypted test can be captured and a copy sent to a computer in another room, for example, or the private key can be copied and a second computer anywhere in the world can simultaneously decrypt the test. Once the test can be viewed by a consultant who is not in the test-takers room, then the consultant can transmit the answers to the test-taker facilitating cheating.

Consider how the consultant might conduct this transmission to the test-taker. Perhaps, the consultant is in an adjoining room and transmits the answers using RF communication to a device hidden on the body of the test-taker which retransmits to a receiver pressed against a bone in the test-taker's head, hidden by his or her hair, or mounted on his or her teeth. Both such devices are readily available. The RF frequencies used can be chosen to be undetectable by any device designed to detect such transmissions since the range of frequencies available span more than 6 orders of magnitude and in addition, frequency hopping techniques can be used. Also, an RF sensor mounted anywhere on the student will not pickup such sounds without knowing the transmitted frequency.

Even if the consultant is in another country as long as he or she can see the test, there is no way to prevent the transmission of the answers to the student. Other methods include vibrators in the seat, wires which attach to the bone mounted speakers, etc. The consultant can even project the answers onto a portion of the room which is not covered by cameras but observable by the test-taker and can even alternate such locations to fool systems that monitor the test-taker's behavior. Basically, there is no method of preventing the consultant from communicating the answers to the student and therefore it is necessary to prevent the consultant from obtaining a copy of the test questions.

If the questions are decrypted on an ordinary computer, then many potential information leakage problems exist. Regardless of the operating system, if the consultant can obtain access to the processor board of the computer, then the connector that connects to the display can be removed and reconnected into a splitter inserted in such a manner that the display operation is unaffected but a second set of wires are now available which contain the display information. These wires can be connected to a small processor which connects them to a transmitter to send the display information to another room by undetectable RF. Alternately, a simple wire can be used, hidden from view of whatever cameras are present. Another approach is to steal the private key which cannot be protected in an arbitrary computer. Once the consultant has the key, then he or she can intercept the transmissions to the computer and decode the test in a second computer. The conclusion is that the private key must be stored and the decryption process must be undertaken in a special protected device which will be discussed below.

Consider now the display. If there is a display where the questions can be seen from anywhere other than the eyes of the test-taker, then there is another path for leakage of the test questions. Assuming that the decryption occurs right at the display and the display is protected from tampering, the display itself can facilitate transmission of the test questions. A camera looking through an undetectable port in a wall or undetectably worn by the test-taker can capture the image of the test questions and transmit this to a consultant by any number of methods. Thus, either the display must be scrambled so that only the test-taker wearing special glasses can see the questions or the display must be so close to the test-taker's eyes that no one else can get close enough to see it. Both of these approaches will be discussed below. The conclusion is that no ordinary display is usable without incurring a risk of cheating.

Some methods for accomplishing the objective of cheating prevention which have been considered include using one or more cameras which can image a substantial portion of the space around the test-taker so that a consultant (or other person aiding the test taker) cannot be located in a position where he or she can influence the test taker without being seen by one or more cameras. A structure has been proposed such that the computer on which the test is being taken will not be accessible by another computer in another room, for example, where a consultant can simultaneously view the exam and communicate the answers to the test taker. If this structure is separated from the display and if the display is not scrambled or very close to the test-taker's eyes, as described above, this approach can be defeated. Also it is not required that the consultant be where he or she can be observed by any cameras.

Similarly, it has been proposed that a microphone is preferably available to monitor the audio environment where the test taking is occurring to prevent audio communication with the test-taker by a consultant. A microphone will not pick up communications from the consultant in the form of RF communications translated into sound at a head bone. The microphone will pick up any oral communications from the test-taker and thus is a necessary part of the system. In order to make sure that the microphone has been activated, a speaker or other sound source may be necessary to periodically create a sound which can be sensed by the microphone. These and other methods and apparatus are discussed below but already it has become evident to the inventor that the apparatus that is used to take the test must be especially design to solve the issues mentioned above.

The identity of the test-taker can be ascertained using one or more of a variety of biometric sensors and systems such as a palm, fingerprint, iris or other scan, a voiceprint, or a good image of the test-taker coupled with facial recognition as further discussed below.

When taking a test, the student can go through a process which sets up the apparatus and validates its operation. The student can then confirm his identity which will have been previously established and stored locally or remotely for comparison. The process of ascertaining the identity can be recorded for validation.

Output from the various monitoring systems can be fed to one or more trained neural networks which have demonstrated a high accuracy, for example.

Each time the student takes a test and demonstrates his or her proficiency in knowing the course work, he or she can be awarded credits and after sufficient credits have been obtained, he or she can be awarded a degree. After the degree award, the student would then presumably begin working for a company, government agency, or other organization and the system should periodically be verified through consultations or surveys with the management of the organization to ascertain that the hiring organization is satisfied with the proficiency of the student as learned on the online courses. This feedback allows for continuous improvement of the overall process and system.

Naturally, the degree granting institution will incur some costs during this process and thus, some payment from the student to the institution may be considered. Depending on the circumstances, this payment can be a charge per course, per test or per degree. Since the earning power of the student can be significantly increased, and the out-of-pocket cost to the institution is small, these payments can be postponed until the student is being paid by a hiring organization and, in fact, such an organization may be willing to cover the payments. In any event, the payment should be very small when compared to the typical cost of a traditional college education. However, the degree-granting institution by this method, can greatly expand the number of degrees granted and thus although the payment per student will be small, the total sum earned by the institution can be large.

A good review of the state of higher education in the United States and in particular of the rise of MOOCs can be found in the Nicholas Carr's article on the subject as published in the MIT technology review. The article can be found on the following Internet website. http://www.technologyreview.com/featuredstory/429376/the-crisis-in-higher-education/. Quoting from this article “Machine learning may, for instance, pave the way for an automated system to detect cheating in online classes, a challenge that is becoming more pressing as universities consider granting certificates or even credits to students who complete MOOCs.” It is the objective of this disclosure to respond to the mentioned challenge.

As discussed in numerous places in the literature, there is a significant difference in the complexity of evaluating a student's proficiency through tests which can be machine graded depending on the course subject matter. For those math and science courses where a numerical answer is to be derived, machine evaluation of the test is relatively simple. However, for those disciplines where a reasoning or writing skill or in particular an artistic skill is evaluated, there is great controversy as to whether this can be done by machine testing. This issue will not be addressed further here other than to note that more research in this area is necessary.

It is not an objective of this disclosure to determine how a test should measure a student's proficiency nor how it should be graded. The primary objective here is to provide confidence to the degree-granting institution that the student who is taking a test is in fact the student who has registered for the course and that the student is acting alone without the aid of a consultant who may be remote or nearby. This assurance should be provided with a probability of cheating reduced to on the order of one in 100,000 and, similarly, the false accusation that cheating is taking place reduced to a similar probability.

When a student decides to enroll in a degree program, for example, or even to enroll in a particular course for which he or she desires credit, the first step will generally be to register with the organization, typically a college or university, and to establish the beginning of the student's record. During this registration process, for the case where the student intends to get credit for one or more courses taken online, the student will be required to submit various types of information which will permit the student to be identified positively over the Internet. Although generally there may be no charge for taking the course, there will generally be some charges related to the test taking and administration of the student's program. In a preferred embodiment of this invention, a specially configured device will be sold or rented to the student to be used primarily for test taking.

A laptop which partially meets the objects of this invention is described below and is configured so that all of the functions necessary to identify the student and significantly reduce the opportunity for cheating are incorporated within the laptop design. At the end of the course or when the student completes his relationship with the institution, he or she may be required to return the laptop at which time, he or she will be refunded some portion of the price of the laptop.

Since the value of a degree from a prestigious institution can be immense, the motivation to cheat when taking a test can be enormous. One can foresee, for example, an industry of consultants developing solely for the purpose of aiding students in taking tests and thus obtaining a degree. The system of this disclosure is therefore configured to minimize the possibility of success of such consultants. Several solutions will be presented with varying complexity and probability for eliminating cheating.

If a student, when taking a test, is inclined to cheat, this inclination can be facilitated if a helper or consultant has access to the display which shows the test while it is being taken. If the consultant has such access, then he or she will use a communication method by which he or she can transfer information to the test-taking student. This disclosure is intended to minimize the opportunity of the consultant from observing the display and/or of being able to communicate with the test taker.

If the student were to use his or her private computer for taking a test, it would be generally relatively easy for a consultant to attach a second remote monitor which would display the same information as the primary monitor. There exists software, for example, which permits someone who is even located remotely from a particular computer to observe the display of that computer. Alternatively, if the student or his consultant has access to the ports and operating system of the computer upon which the student takes tests, access to the information on the display is relatively simple to achieve. The only method of preventing this is to design a laptop computer which prevents other computers from connecting with the computer and copying the display. Thus, in a preferred implementation of this disclosure, it will be assumed that a special computer has been configured and provided to the student for those cases where the student desires credit for the course he or she is taking.

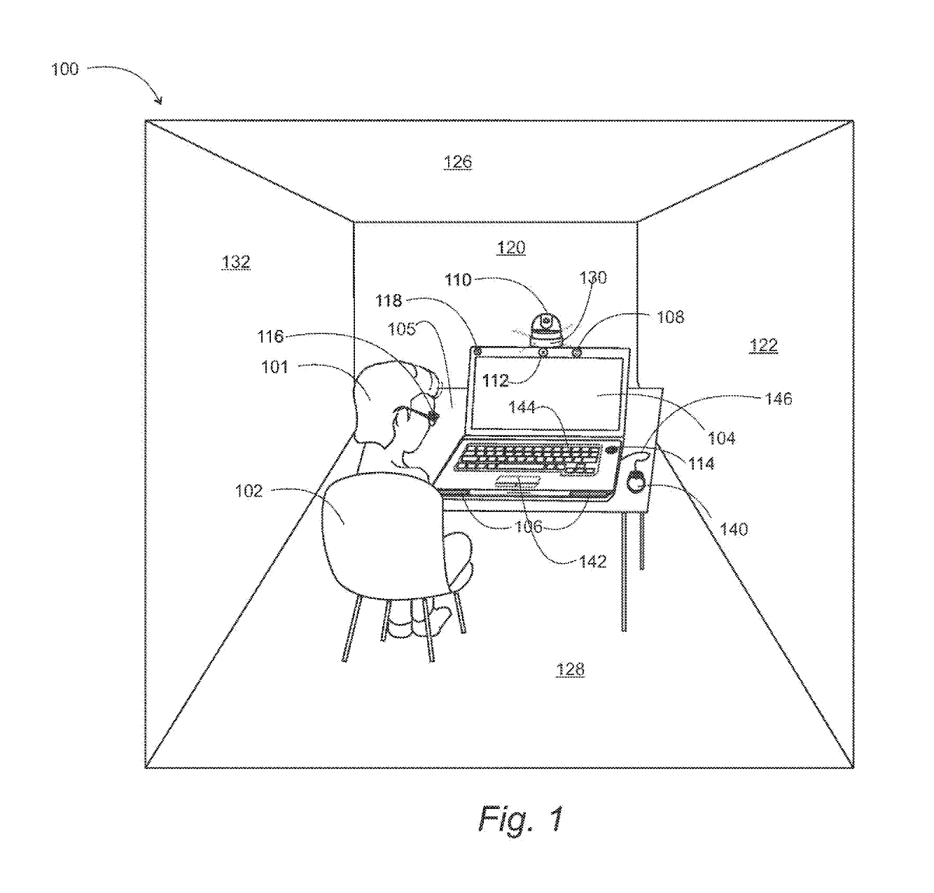

FIG. 1 illustrates a room 100 in which a student 101 resides taking a test, for example, one related to a course for a degree. The student 101 sits on a chair 102 and operates a laptop computer 104 which rests on a table 105. Integral with the laptop 104 are various devices which will now be explained. A set of stereo speakers 106 can be provided which will allow oral communication from the laptop computer 104 to the student, for example, instructions for taking the test and any oral scenarios or questions that form part of the test.

The speakers 106 can also be used to validate that a microphone 108 of the laptop computer 104 is operational. This is accomplished by the speakers 106 emitting periodically a noise which can be sensed by the microphone 108. Since a logical means of communication between a consultant and the student will be orally, the microphone 108 will be used to sense such oral communication. That is, the microphone 108 can be used to monitor noise in the room 100 and determine, for example, that the test-taker is talking or a person other than the test-taker is talking. In either situation, the test-taker may be instructed to terminate the test and considered to have failed the test. If the test-taker is talking, then there are many ways for a consultant to respond which may not be observable using a given set of cameras and microphones.

A test-taking student, therefore, who desires to cheat and receive oral communications from a consultant may attempt to block or disable the microphone 108. Therefore, a check that the microphone 108 is functioning properly can be obtained by listening for the periodic sounds sent by the speakers 106. In order to minimize the distraction of sounds, they could be of either very short duration sounding like static or in a frequency range which is beyond that sensed by human ears.

More generally, the laptop computer 104 includes componentry that performs audio monitoring of the room 100. This monitoring entails a known, continual or periodic sound emission along with audio reception and comparison of the sound emission to reception. The monitoring may be initiated when it is known that the test-taker is the only person in the room 100.

An imaging system, such as two laptop mounted cameras, 110 and 112, are used in this embodiment. Camera 110 provides a panoramic view of the space surrounding the laptop computer 104 and is used to check for the presence of a consultant or other person, or device which could aid the student 101 during test taking. This camera produces a continuous stream of images which are continuously analyzed by an anomaly detection algorithm to determine if any suspicious events are taking place. This camera 110 as shown provides a hemispherical view of the room but there is a substantial portion of the room which is not observed by the camera 110 permitting a substantial area for communication to the student 101. Such communication can use the floor, for example, as a screen for projected information.

The images from the cameras 110, 112 can be evaluated for suspicious behavior through the use of a trained pattern recognition anomaly detection algorithm which has been trained on a large number of normal and suspicious situations as described in, e.g., U.S. Pat. No. 5,845,000. This algorithm is resident in computer-readable memory of the laptop computer 104, and executed by the processor thereof.

The field of view of the camera 110 covers preferably a full hemisphere above the horizontal plane containing the base of the camera 110. A person, for example, that enters the field of view of the camera 110 from any direction will trigger the anomaly detection algorithm to determine whether such a person is interfering or communicating with the test-taking student 101. In general, if any individual enters into the space around the test-taking student 101, it will be assumed that the rules of the test taking process have been violated and an error code initiated.

The second camera 112 is similar to cameras which are frequently present in laptop computers and is used to monitor the operator of the computer, i.e., the test-taker 101. As with the output from camera 110, the output from this camera 112 can be analyzed by an anomaly detection algorithm, such as a pattern recognition algorithm, which will detect any suspicious behavior on the part of the test-taker 101. For example, if the student spends an inordinate amount of time looking at an area which is not covered by camera 110, such as the floor, he or she can be advised to stop such looking as the floor, for example, may be being used by a consultant to project helping information to the student. Of course, a determined cheater can take this into account and vary the directions of the consultant's projector. Therefore, for this to be effective the room monitoring camera system should cover the entire room.

A biometric device 114 is shown here as a fingerprint measuring sensor integrated into the laptop computer 104. Other biometric devices and systems can be present to validate the identity of the test-taker 101 as described herein. These biometric devices may be integrated into the laptop computer 104 or may be otherwise attached thereto to form a common unit with the laptop computer 104.

In some cases, particularly when the test is a closed book exam where the presence of textbooks and notes are forbidden, the test-taker 101 can be required to wear a camera 116. This camera 116 will record the field of view which is seen by the eyes of the test-taker 101 and therefore if any visual aids are provided to the test-taker 101, these visual aids will be recorded by this camera 116. This camera 116 is similar to the camera which is part of Google Glass; however, the remaining aspects of Google Glass do not have to be part of this camera system. In order to assure that the camera 116 is properly worn, camera 112 can be used to monitor the test-taker 101 for the presence and proper wearing of the camera 116. More generally, a verification system, whether embodied as hardware or software, to verify that the camera 116 is properly worn by the test-taker 101 can be incorporated into the system.

The walls of the room 100 are indicated in FIG. 1 at 120, 122, and 132, the floor is similarly noted as 128 and the ceiling as 126. Some possible uses of these walls to aid the test-taker will be described below.

An indicator light 118 can also be part of laptop computer 104, i.e., integrated into the laptop computer or otherwise attached thereto to form a common unit with the laptop computer 104. Indicator light 118 can be used to give a light indication that the test is underway to alert others not to interfere with the test taking process. This light 118 would be typically on during the test taking process and be turned off thereafter. The light 118 can also be used to indicate that an error code has been developed by one of the sensor algorithms indicating that there is suspicious activity underway, e.g., the test-taker 101 is interacting with another person in the room 100. In such a case, the test may be invalidated. This can be indicated by the light 118 either through the color of the light 118 or perhaps through an intermittent operation or blinking of the light 118. In the event that this happens, the test-taker should be directed to cease taking the test and rectify the event which caused the error condition, after which he or she can restart the test or continue depending on the rules established by the institution.

An objective of this test taking system is that it is completely automatic without requiring the intervention of any human other than the test-taker 101. The institution administering the test will have a set of rules which, if violated, will render the test invalid. These rules can be general rules or rules specific to the particular test being taken. These rules can include the events which will invalidate a test, the number of times that the test, once an event has occurred, can be restarted if any, the number of times that a particular test can be taken if failed, the time permitted to take the test, the number and length of pauses permitted during the test taking process, etc. The rules may or may not be notified to the test-taker 101.

All of this puts a burden on the institution to draw arbitrary lines as to what constitutes cheating and what does not. A problem with the dedicated laptop approach is that it is still possible to cheat. Although a substantial number of sensors have been introduced, each of these sensors requires an algorithm to assess the sensor output and determine whether the test-taker is cheating or not. Unless the laptop is provided with a chassis intrusion detector (CID), as discussed below, it would be easy for a consultant to modify the laptop to transmit the display information to another room. Even with a CID there are accessible wires which connect the display to the base. These wires can be cut and a splitter spliced in again allowing the display information to be sent to another room. Finally, the display itself is not protected. The test-taker 101 can wear a camera which has a lens the size of a small pea which can peak through a button hole or other hole in the blouse or shirt which blends into the pattern and is virtually undetectable by a web camera mounted on the laptop. Alternately, such a camera can look thought a hole in the wall or in some object in the room and be undetectable. Of course, once a cheating method is discovered, it will quickly become public through the Internet, defeating the laptop solution. Thus, although the dedicated laptop is a substantial improvement to the state of the art, it introduces new burdens on the test provider and typically cannot achieve the accuracy desired.

Generally, the test will be downloaded to the laptop computer 104 as requested by the test-taker 101 using a user interface integrated into the laptop computer 104. The download will preferably be encrypted and can only be decrypted by the particular designated laptop computer 104. This decryption is enabled by decryption software resident in the memory of the laptop computer 104. Thus, even if another computer can intercept the test while it is being downloaded, it will not be able to decrypt the download unless the private key can be found and copied from the laptop which would be an easy task unless prevention measures discussed herein are undertaken.

The private key used to decrypt the downloaded test can be a permanent part of the laptop operating system and stored in non-volatile memory of the laptop computer 104 which cannot be accessed without destroying the laptop computer 104 except by the test administering software. To this end, a tampering detection system would be configured to detect tampering with the non-volatile memory component of the laptop computer 104 to detect whether it has been compromised, accessed impermissibly and then an indication of such access removed. For this reason, the laptop computer 104 will preferably contain diagnostic checks to ascertain whether the computer 104 has been tampered with. If there is an indication of tampering, upon the next linking of the computer 104 to the Internet, an error code will be uploaded and the laptop computer 104 declared invalid for future test-taking purposes. However, if any software can access the private key, a hacker can write new software which can spoof the test administration software and capture the private key. Once this is done, the private key can be loaded onto another computer which looks to the test administrator to be identical to the test-takers laptop. Similarly, any information written to non-volatile memory can be read if the computer is destroyed in the process. This is commonly done to reverse engineer software. Once read, it can be loaded into another computer which is indistinguishable from the original. Although this is expensive and the camera method of copying the screen would be substantially easier, it is still a vulnerability which will and should cast doubts in the minds of test administrators.

These diagnostic checks may be resident in computer-readable storage media that form part of the laptop computer 104. It is also possible for the tampering detection system of the laptop computer 104 to be partly resident at a remote site. In this case, the remote site would send a command to the laptop computer 104 to perform a diagnostic check to detect tampering with the computer 104. If such tampering is detected, the test may not be downloaded, i.e., the computer 104 has been compromised and can no longer be used. Although this is another deterrent, it too can be defeated with appropriate software.

A motion detector, and particularly an ultrasonic motion detector, is also integrated into the laptop computer 104 or otherwise attached thereto to form a common unit with the laptop computer 104. The ultrasonic motion detector may comprise an ultrasonic transceiver assembly 130 mounted on the top of the display of the laptop computer 104 axially in-line with the video camera 110. This ultrasonic transceiver assembly 130 can consist of a plurality of ultrasonic transducers, e.g., six or more each having a 60° transmission and reception angle, for example. There are many commercially available motion detectors comprising a single unit which covers the entire space in the vicinity of the test-taker 101. Although such devices can detect motion anywhere within a known distance from the device, they are generally notorious for giving false alarms and they do not provide the direction of the offending object. A window shade moved by the wind is treated the same as a consultant entering the room. Also, they do not provide for range-gating to remove the area occupied by the test-taker 101.

Accordingly, the laptop computer 104 may be provided with a housing that has an integral or integrated biometric device 114, as well as an integral or integrated panoramic camera 110 and a motion detector. The laptop housing is known to those skilled in the art, with appropriate apertures, supports, coupling, etc. being provided to enable electrical and signal coupling between the laptop processor and each of the biometric device 114, the camera 110 and the motion detector. The processor is typically housed within the base of the laptop computer 104. The panoramic camera 110 is shown housed in the cover of the laptop computer 104 with the display. The motion detector is also shown housed in the cover. These locations are exemplifying only and each of the biometric device 114, the panoramic camera 110 and the motion detector may be housed either entirely in or on the base, entirely in or on the cover, or partly in or on the base and partly in or on the cover. There is no limitation as to the positioning of these components, so long as they are preferably integrated into the structure of the laptop computer 104 to be considered as one portable unit with the laptop computer 104.

The ultrasonic transducers can be driven by circuits which can be adjacent the transducers and software which can be resident within the laptop computer 104 to periodically admit a burst of ultrasound at one or more appropriate frequencies, such as 40 kHz. This sound will travel from the transceiver into the space around the laptop computer 104. Using the principle of range-gating, ultrasound waves which are returned prior to T1 milliseconds from the time of emission from the transceivers can be eliminated from the returned signal, thereby providing a space of perhaps 2 m radius around the computer 104 in the direction of the test-taker so as to block out any returns from the test-taker 101. Similarly, returns after T2 ms can be eliminated from the data set. If T1 and T2 are set corresponding to returns from 2 and 10 m respectively, approximately 12 ms and 60 ms allowing for travel in both directions, the ultrasonic system will record returned waves from objects that are between 2 and 10 m from the transceivers. Software can then compare successive receptions to determine whether there has been any change in those receptions and, if so, the software can indicate that there is a moving object in that 2 to 10 m range. Such an object may be a consultant sending messages by gestures or signs, for example, to aid the test-taker 101.

At the discretion of the institution, a time limit or no time limit can be afforded the test-taker 101 for completing the test. Similarly, a course can have only a single final exam or a series of quizzes in addition to a final exam or feedback can be requested from the test-taker 101 during each course session depending on the course and the desires of the institution. Since all such tests will be graded automatically, the cost of having daily or more frequent quizzes versus a single final exam is insignificant. In one extreme case, all of the required courses can be given without any exams and a final comprehensive exam can be used to validate a student for receiving a degree. Alternately, the student can be tested continuously during the course or degree process without any final examinations. These decisions are left up to the institution.

The student can enter data into the testing program through a keyboard 144, a track pad 142, and/or a mouse 140, or any other type of user interface such as a touch screen of the laptop computer 104. The mouse 140 is illustrated as attached to the computer 104 with a fixed wire 146. An alternate arrangement is to provide a special mouse having a special connector that only attaches to the specially configured laptop computer 104. The mouse 140 can also be wirelessly connected to the computer 104 through a special wireless protocol which only allows a particular mouse design to communicate and limits the messages which can be sent to those that are associated with commands from a computer mouse. Bluetooth or other standard protocol can be used with the mentioned limitations as to the data that can be transferred. Of course, all of these protections can be defeated by one skilled in the art with sufficient motivation if access to the inside of the laptop can be obtained.

The camera 110 and/or the ultrasonic transceiver assembly 130 can be assembled into a package which folds into a special compartment, not shown, built into the top of the laptop computer 104. This protects the mentioned hardware from damage when the computer 104 is transported from one location to another. Similarly, the camera and/or ultrasonic transceiver assembly 130 can be connected to the computer 104 through an appropriate connector and thus removable when the computer 104 is not being used.

Other considerations and modifications to the system include providing an electromagnetic shield on the back of the display to prevent information as to the contents of the display from being sensed by a sensing system mounted out of camera view on the back of the laptop display lid. Additionally, it has been proposed that a general electromagnetic receiver, not shown, can be incorporated into the laptop computer 104 to sense whether there are any spurious electromagnetic signals which might indicate a transmission of information from a consultant to the student. However, such a device does not exist which will cover the availability of the RF spectrum. A similar device has been suggested to sense ultrasonic transmissions, but again, if the transmission frequency is not known, it cannot be sensed. For example, perhaps the student is wearing a hearing aid-type device which contains an electromagnetic receiver but which cannot be visually seen by the system's cameras. Since the available spectrum exceeds six orders of magnitude, there is no general way of detecting such a transmission. Highly directional electromagnetic radiation might still be impossible to be sensed by an electromagnetic receiver even if the transmission frequency is known. This becomes even more difficult if the spectrum is expanded to include the far infrared or far ultraviolet light.

Various biometric technologies for verifying the identity of the test-taker will now be discussed. A common biometric device employs fingerprints and a sensor 114 for fingerprints has been included as part of the special laptop computer 104. Various photographic biometric technologies have been developed which can be implemented using either the supplied camera 112 or and a specially configured camera not shown. These include a measurement of hand geometry or a palm print which can record the patterns of blood vessels in the palm of the student when properly illuminated. One of the most accurate camera-based biometric systems uses an iris scan or a retinal scan. Face recognition technology also exists based on a camera image which can be used to recognize the test-taker. A more sophisticated facial recognition technique makes use of facial blood vessels. Another technique is based on making a three-dimensional model of the shape of the test taker's head. One problem with facial recognition is the variation in facial hair between images.

The laptop microphone(s) 108 can be used to record the voice of the test-taker 101 and produce a voice print which would be unique to that particular person. In this case, each time the test-taker 101 takes a test, he or she could be require to speak a sentence to enable comparison of the recorded voice print to the current voice print. Thus, the microphone 108 can be part of a verification system for multiple tests to ensure the same test-taker 101 is taking multiple tests in a series of tests. Problems can arise if the student has lost his or her voice.

Other biometric techniques include having the test-taker 101 sign a provided pad surface which can be also an integral part of the surface of the laptop computer 104. The typing style has also been suggested as a method of biometric the identifying a particular person. A preferred approach is to use two simple technologies such as fingerprints and face recognition. Neither is 100% accurate, however, the combination of the two can achieve very high accuracy. Finally, there are chips under development which can identify a person by chemicals that are present on the student's skin. Also sensors are under development which can identify a person by the odor he or she emits. Such chemical and odor sensors are also encompassed by biometric sensors herein.

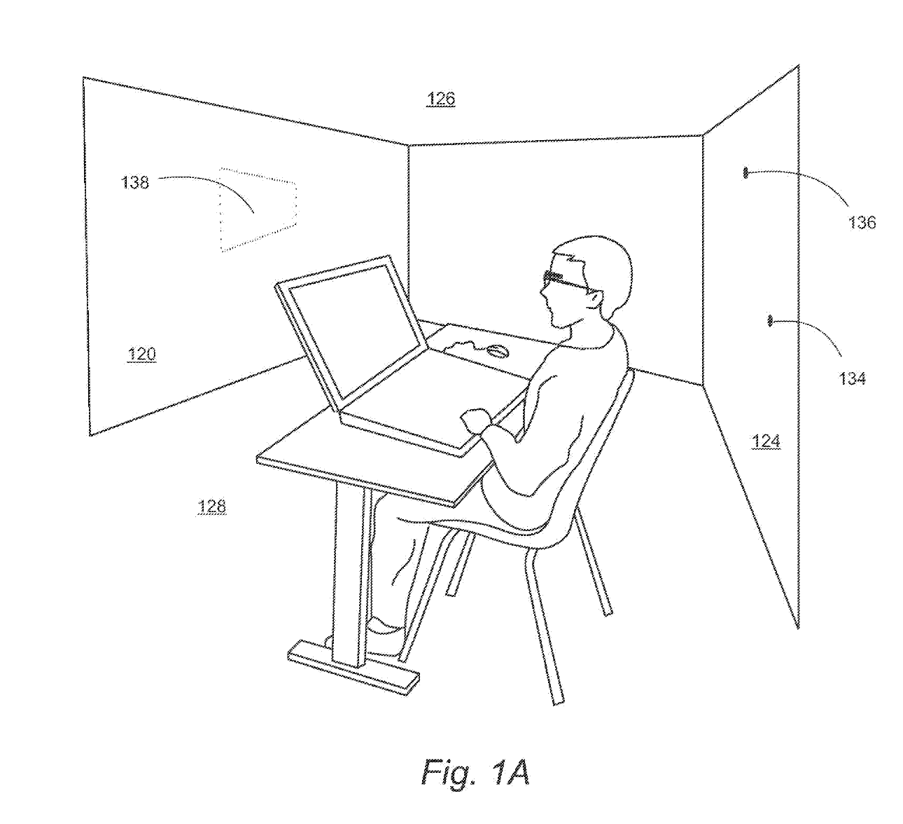

FIG. 2A represents an assemblage of six ultrasonic transducers (designated 1-6) each with an approximately 60° angle for transmission and reception each connected to common electronic control electronics. FIG. 2B similarly represents an array of six cameras each with an approximately 60° field of view which feed into electronics (processor and processing software) which merges the images to create a 360° by 60° composite image of the room 100 to be analyzed by a pattern recognition algorithm such as a neural network. FIG. 2C illustrates the use of a speaker which emits a sound which can be received by a left and/or a right microphone 108. The sound can be of a form which is not objectionable or distracting to the test-taker 101. This can take the form of a frequency which is above or below the human hearing range or of a low level static for example.

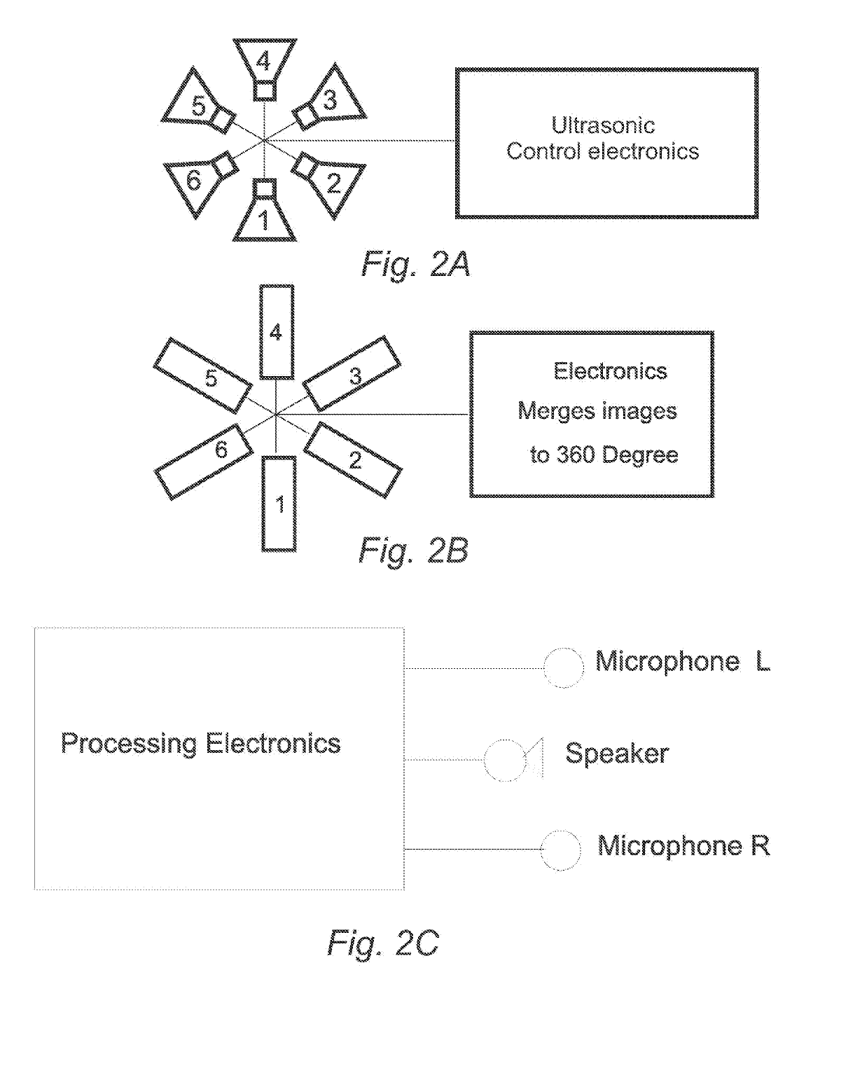

An exemplifying, non-limiting system process flowchart is illustrated generally at 200 in FIG. 3. At step 202, to begin a test using the laptop computer 104, the student opens the laptop computer 104 completely which powers up the laptop computer 104 and the laptop computer 104 attempts to log on to the Internet and communicate with the test providing institution. If this communication attempt is successful, then the student 101 will be prompted to identify himself which may include his student identification code or number at step 204. At step 206, the biometrics of the student is/are measured and checked to validate that this is the student whose record has been accessed at the institution. Such biometric identification codes may have been previously stored at the institution associated with the students ID as discussed herein. If the student is confirmed based on the measured biometrics, the student is prompted to enter the identification of the course for which he or she desires to take the test at step 208. Software at the institution then determines the appropriate test to be provided to the student, for example, based on his or her progress to date. Once the appropriate test has been determined, it is downloaded and decrypted by the laptop computer 104 at step 210. The initial page of the test is then displayed on the display of the laptop computer 104 and the student indicates his or her readiness to start the test at step 212.

The test timer is then started and the test in-progress light 118 is illuminated at step 214. At step 216, the student 101 takes the examination. When the student 101 has completed the test, he or she indicates this by an appropriate computer keyboard entry and the test is completed. At this point, the answers can be encrypted, although they do not need to be since the answers do not display the questions, and transferred to the institution over the Internet and the test in-progress light 118 is turned off.

When the laptop computer 104 is opened to its maximum position, which can be at a particular angle such as 135 degrees, the computer 104 can be automatically turned on. The laptop computer 104 and its top containing the display is configured to operate at this angle and the computer 104 can be configured to turn off or go into a sleep mode if the top is rotated relative to the base at any time. A tilt sensor can be incorporated in the laptop computer 104 which measures the angle of the computer base. If the base is not close to being perpendicular to the gravity vector, that is parallel to the floor within about 5 degrees, then panoramic camera 110 will not properly record the surrounding space and the student should be warned to find a flatter surface for taking the test. The panoramic camera 110 and the ultrasonic motion detector can be combined into an assembly which can be detached from the cover of the laptop computer 104 or otherwise folded into a recess therein to protect it from damage when the computer 104 is not in use.

Consideration is necessary concerning where the test-taker's biometrics are stored. If they are transmitted to the test-providing institution, then there is the risk that if they are not encrypted that the transmission can be captured, allowing a consultant to log on as the test-taker in the future. If they are encrypted at the laptop, then even the encrypted biometrics can be captured and used by the consultant. A solution is for the institution to transmit an encrypted random number to the laptop which combines that number with a code representing the success or failure of a biometrics measurement and transmits a combination of the decrypted random number and the code back to the institution. For example, assume that the random number was 45896 and 1 represents a biometrics failure and 0 a success. The laptop upon failure of the biometrics test would return 45897 to the institution and the institution would then not proceed with the test. Thus, if the private key is secure on the laptop, then only the laptop needs to know the test-taker's biometrics which will be stored only locally and can be stored in a coded manner which makes spoofing by another system difficult or impossible.

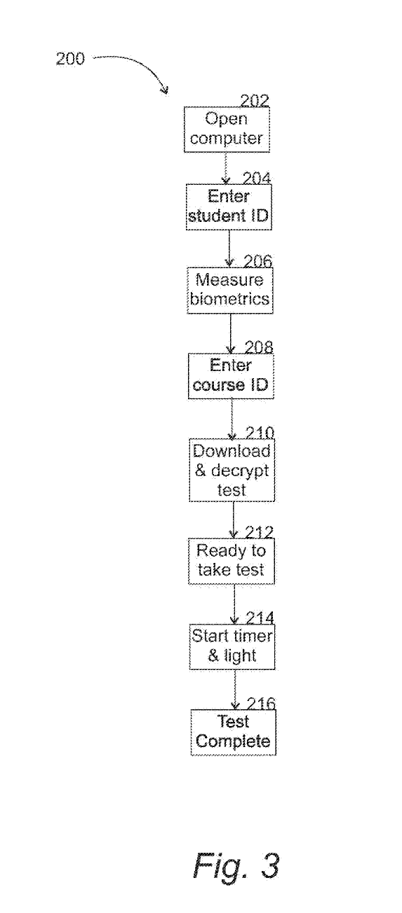

FIG. 4 provides a flowchart for an encryption/decryption scheme shown generally at 300 (corresponding to step 210 in FIG. 3). At step 302, the test is downloaded and at step 304, the private key is retrieved, typically from a memory in the laptop computer 104 as discussed herein. At step 306, decryption using the stored private key is accomplished and at step 308, a time stamped message is sent to the testing institution indicating that this decryption was successful. At step 310, the test is displayed on the student's laptop waiting for an indication from the student that he or she is ready to proceed.

To use a laptop in this manner, the chassis should be protected with a chassis intrusion detector with the private key stored in RAM volatile memory with its own long life battery power supply as described herein. If this is not the case, then the laptop can be opened and the display images transmitted off the computer, and if the private key is stored in nonvolatile memory, it can be retrieved and used by another computer which is designed to spoof the laptop. With the cost of education approaching or exceeding $100,000, there is ample motivation to undertake these actions.

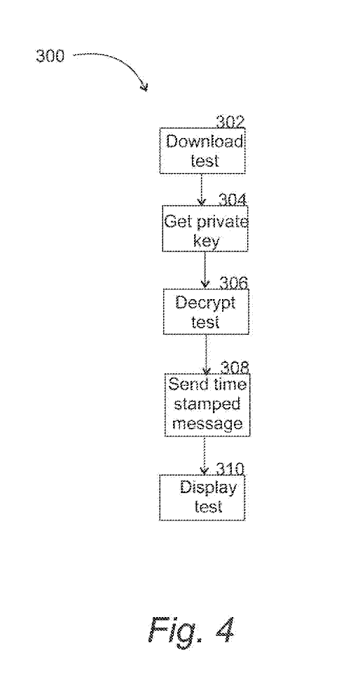

FIG. 5 illustrates a pattern recognition flowchart shown generally at 400.

A properly trained general pattern recognition process can be used for any of the biometric data retrieved by the sensors listed above including facial recognition, voiceprint, palm print, fingerprint, iris scan patterns, signature recognition, or any of the other pattern-based biometric identification systems described herein. The biometric data is acquired at step 402 and input into the pattern recognition algorithm which can be a properly trained neural network at 404. If verified, this information is sent to the institution, as described above, which returns a code indicating that it is okay to proceed with the test taking process at step 406. Specifically, the institution compares the transmission received with the sent random number and indicates whether the test taking is allowed to proceed, so that the test taking procedure proceeds at step 408. Alternately, the appropriate neural network check of the biometric test data can be accomplished at the institution, in which case, the data is transferred to the institution. However, this adds significant risk to the process as described above, so it is not recommended. If agreement between the stored biometric data and the newly acquired biometric data does not agree, then the trial count is incremented by one at 410. If the trial count has not exceeded the maximum permitted as determined at step 412, then the student is requested to initiate a re-acquisition of the biometric data and the process repeated. If the maximum number of tries is exceeded, then the test is not downloaded and the student is logged off of the session at step 414.

A variety of commercially available cameras are available for acquiring a panoramic view as required by camera 110. As disclosed above, a preferred implementation of this disclosure uses a specially configured laptop computer 104 so as to make it difficult for a consultant from simultaneously acquiring an image of the test so that he or she can coach or help the test-taker 101 during the testing process. The specially configured laptop computer 104 makes the interception of the data which is displayed difficult but not impossible on the student's monitor by another device. It is also configured to make the implementation of screen sharing software or any other technique by which a consultant could simultaneously view the student's display from another location difficult. Nevertheless, there are still other methods by which this can be accomplished some of which have been addressed above.

One example is for consultant to install a very small camera in wall 124 of FIG. 1A in such a location as to have a view of the screen of the laptop computer 104. The position of the laptop computer 104 and the table can be chosen by the consultant or test-taker so as to permit such a view. A camera 134 on wall 124 can comprise a telescopic lens with a very small aperture looking through a hole in the surface of wall 124. If necessary, this hole in the wall 124 can be covered with a one-way mirror. Alternately, the camera 134 can be sufficiently small as to be virtually imperceptible to the panoramic camera 110. Such a camera 134 would give a consultant, who could be located in an adjoining room on the other side of wall 124, the ability to simultaneously view the screen along with the test-taker. There still remains the problem of how the consultant would communicate help to the test-taker.

In addition to the camera 134 protruding through wall 124, a small projector lens can likewise protrude and display images 138 on an opposing wall 120, ceiling 126 or floor 128. In order to be not observable by the camera 110, the projection can be in the form of polarized light superimposed on light having a different polarization or by some other method unobservable by an ordinary camera but observable by a camera with a properly polarized lens. The test-taker 101 can then wear polarized glasses and thus able to observe the information that has been projected. The display can be moved around so that a camera viewing the behavior of the test-taker would not detect any unusual behavior. Alternatively, the room illumination light can be modulated in such a manner as to not be perceived by the camera 110 and processing software, yet the information can be extracted by electronic circuitry mounted into a hearing aid type device, for example. This device can decode the information and convert it to sound and made available to the test-taker 101 through the hearing aid or as bone- or tooth-mounted speaker.

In another configuration, the test-taker 101 can wear a hidden hearing aid type device which contains an electromagnetic receiver permitting the consultant to talk to the test-taker 101. Ultrasonics could be used to transmit data to the test-taker 101 where it could be decoded into audible sound and fed to the test taker's ears or converted to head bone vibrations. A haptic device could be placed on chair seat or within the clothes of the test-taker 101 and caused to vibrate giving an indication of what action the test-taker 101 should take with regard to a particular question. This haptic device can have an electromagnetic receiver tuned to a transmitting device used by the consultant.

Once any of these techniques is found to be in use, a sensor system that senses and blocks the system can be configured and made a part of this test taking system. However, this could escalate into an unending sequence of detection, sensing, blocking and variation of the transmitting method. The penalty which the student would suffer if caught cheating, of course, would be catastrophic to the student's career which in itself would serve as an impediment to use of such systems. Nevertheless, a continuous improvement process is required wherein the system designer surveys organizations which have hired students based on credentials obtained through MOOC courses employing the test taking system disclosed herein. Nevertheless, since the possibilities for communication from the consultant to the student are limitless, the system designers will always be behind the consultant's methods.

When using the laptop computer described above, an objective is to prevent viewing of the display screen by someone who might try to assist the test-taker. The techniques disclosed above make visualization of the display difficult for anyone other than the test-taker. However, to address the possibility of, for example, a telescopic lens camera mounted in a wall which might enable the content of the display screen to be viewed and the viewer thus capable of providing assistance to the test-taker, another embodiment of the disclosure raises the bar and limits this possibility.

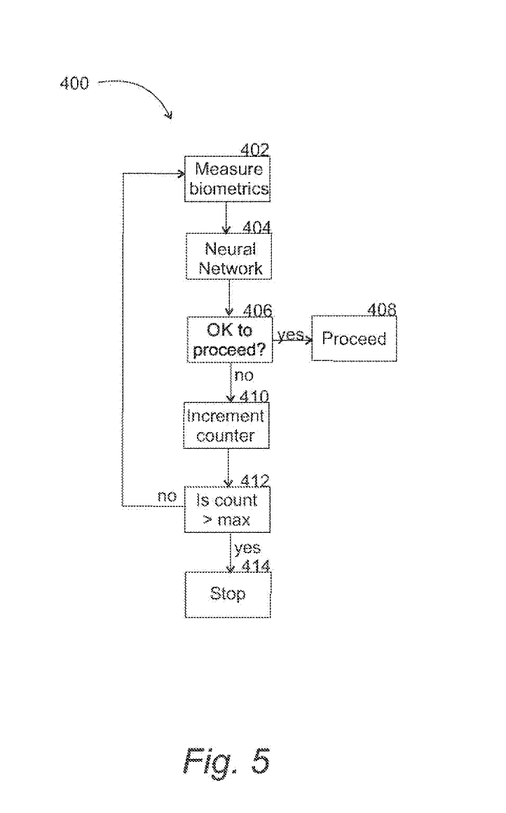

Referring now to FIGS. 6-12, this embodiment of the disclosure does not require a special laptop computer to facilitate secure test-taking. Rather, in this embodiment, the test-taker can use a tablet computer or other non-specialized computing device. However, other components are required including a head-mounted apparatus and an equipment tower 20.

Tower 20 may be generally considered a structure that provides an elevated platform above the computer being used for test-taking, not shown in FIG. 6. As shown in FIG. 6, the tower 20 includes a vertically oriented support 22 into which a processing unit 24 is mounted. The tower also has a camera assembly 26. The processing unit 24 controls the testing process, in a similar manner as described above. The support 22 may be a tripod configured to rest on a horizontal surface such as a table, or the floor in the vicinity of the computer being used for test-taking. When placed on the floor, the support 22 may be configured to be collapsible, in the same or a similar manner in which a camera tripod is collapsible, and the support may be from about 5 to about 6 feet high. When configured for table-top placement, the height of the support 22 would be less.

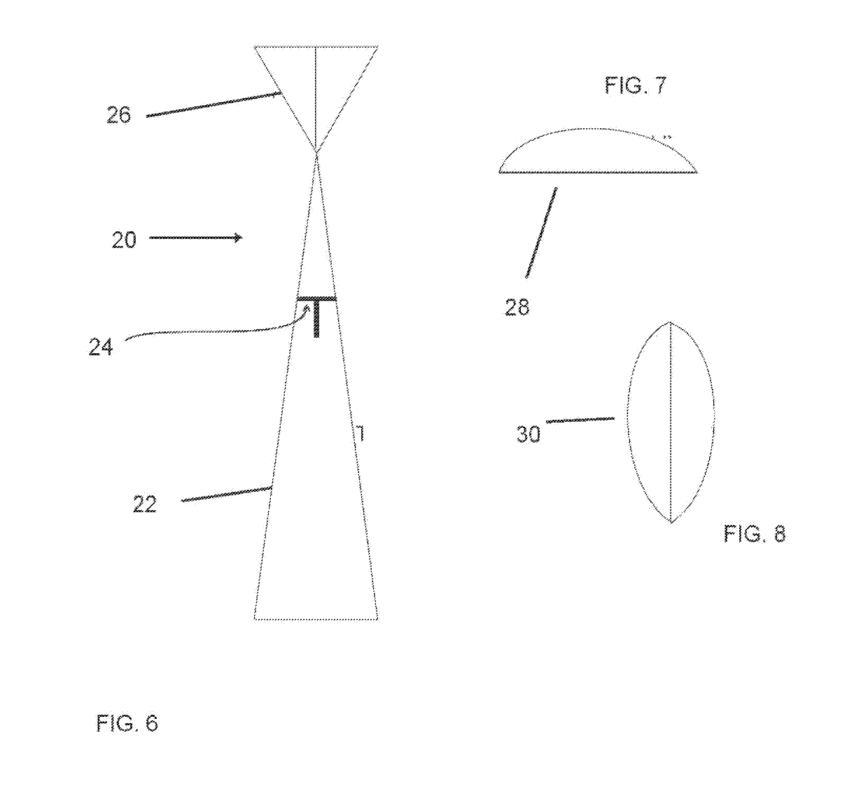

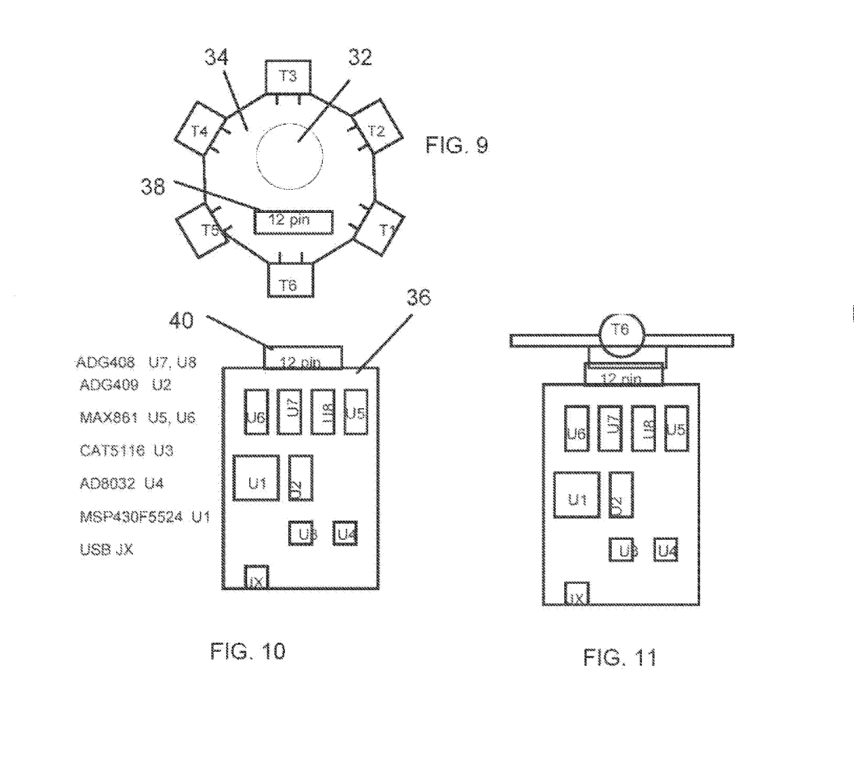

The camera assembly 26 may be composed of 4 imagers in a tetrahedron arrangement or two hemispherical imagers when the entire room is to be monitored. Each of the imagers would have a special lens such as a fisheye lens, as illustrated at 28 in FIG. 7 and at 30 in FIG. 8, in order to capture the maximum field of view. Other configurations using more imagers can be used to accomplish full room coverage. It is also possible that for some implementations where full rom coverage is not desired, other imager configurations are possible. When the tetrahedron camera assembly is provided, it can have its corners removed since there is no reason for them to extend beyond the camera. Instead of associating a fisheye lens with the imager 28, other types of lens may be used. Indeed, since a square imager may be used in the disclosure and fisheye lens are often round, accommodations to address this shape different will be utilized.

In addition to camera assembly 26, other cameras may be arranged on the support 22 to view the area around the computer being used for test-taking and/or the test-taker. One camera might be optimized for viewing the computer while another might be optimized for viewing the test-taker. The specific camera location of these other cameras may depend on the structure of the support 22 or the camera on the computer may be used. However, as shown in FIG. 6, the camera assembly 26 is preferably mounted at a top of the support 22.

The dual camera 30, the outline of which is shown in FIG. 8, may be used instead of the tetrahedron camera assembly. Such a dual camera 30 could likely provide a full spherical image. Details of this aspect are set forth in U.S. Pat. No. 7,161,746.

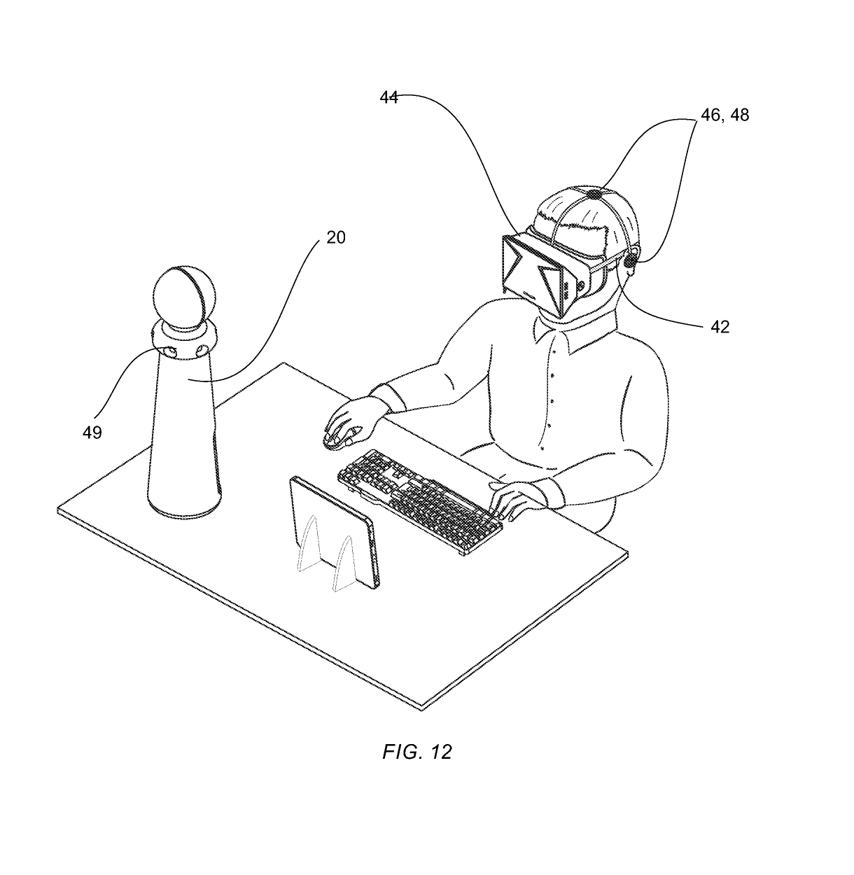

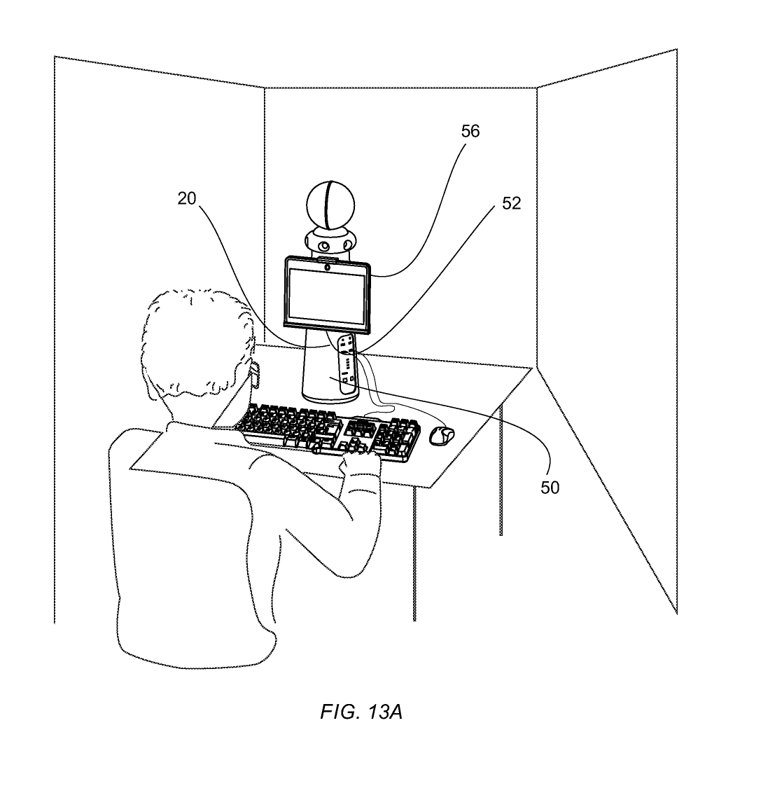

The processing unit includes a connection port to enable a cable to extend from the processing unit 24 to the computer being used for test-taking. This cable may the only connection between the processing unit 24 on the tower 20 and the test-taking computer. The cable may extend through an aperture 32 in a transducer board 34 shown in FIG. 9. Transducer board 34 may be part of the processing unit 24. This cable may be a USB cable with appropriate connectors placed on the computer and the transducer board 34 to enable correct engagement. Another USB cable may also be provided to connect to an ultrasonics board 36 shown in FIG. 10. The ultrasonic transducers making up the sensor array are connected to the ultrasonics board 36. The ultrasonic sensor array is an example of a motion sensor that may be used to monitor movement in the vicinity of the test-taker, and other motion sensors of course may be used. Instead of cables, wireless connections may be considered.

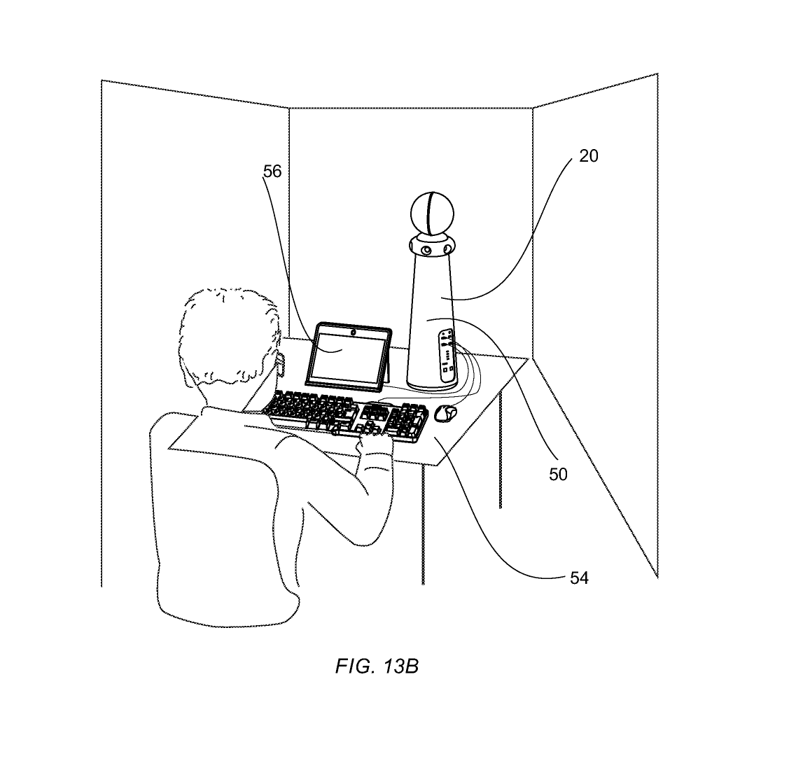

FIG. 11 shows the connection of the transducer board 34 and the ultrasonics board 36 via mating 12 pin connectors 38, 40. The support 22 can also include an angle sensor (not shown). In combination, the camera 26, ultrasonic sensor array and angle sensor monitor the environment surrounding the test-taker. Other types and combinations of environment monitoring systems and sensors may be used in accordance with the invention. The support 22 may also include one or more sound sensors and/or one or more sensors for detecting RF communications that can reach the test-taker. These sensors may alternatively be provided on another unit.

Use of this embodiment would involve the test-taker accessing the test-providing website, as described above, and proceed to take the test using their computer in the vicinity of the tower 20. The tower 20 would monitor the presence of other people in the vicinity of the test-taker, some communications toward the test-taker, verify the identity of the test-taker, etc., basically a subset or all of the features performed by the computer and arrangement described above with respect to FIGS. 1-5. One or more biometric sensors or other identity-verification sensors or systems may be coupled to the processing unit 24, and may even be integrated into the computer.

Although this configuration essentially provides all of the same features as the special laptop implementation, it has the feature of not requiring the purchase of the special computer. Instead the test-taker can use his or her own computer and purchase a less expensive tower which contains all of the decryption and security features which were added to the laptop computer. The tower 20 can be protected using a chassis intrusion detection system as described below, but a display is still needed, unless the test-taker's computer is a tablet computer which is docked to the tower as described below. If the monitor is separate from the tower, then the problems related to securing the display signal described above come into play. Even if it is docked to the tower 20, it too would need chassis intrusion detection or the tablet can be modified to transmit the display image to another room. Alternatively, the display can be made an integral part of the tower 20 and the vulnerable parts of the total assembly properly protected with a chassis intrusion detector (CID).

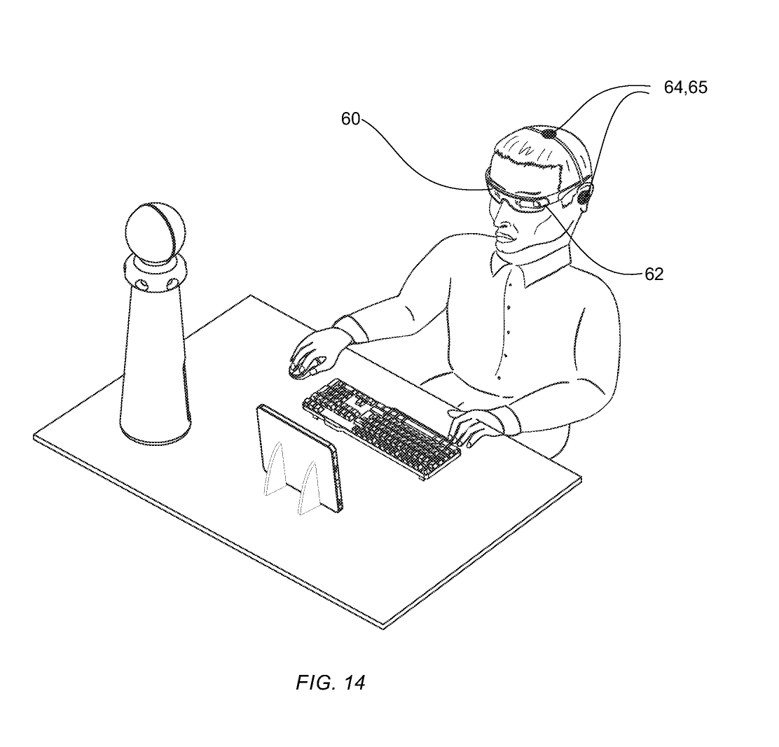

Another embodiment of the invention which may be used in combination with the tower 20 or without the tower 20 is to use a frame that is worn by the test-taker on their head, i.e., head-mounted, and provides a screen, not shown, in front of the test-taker's eyes. As shown in FIG. 12, this frame includes a housing 44 that has the screen and a strap 42 that straps the housing 44 around the user's head. Such a device is commercially available as an Oculus Rift™. An advantage of the use of a frame that is worn by the test-taker is that only the test-taker can view the material being displayed. As such, it is virtually assured that no one else can provide assistance to the test-taker after viewing the display screen that displays the test, providing the decryption is accomplished within the device and the electronics are protected with a chassis intrusion detector as described below. The tower 20 with the RF communication sensors and microphones are thus not as important and can potentially be eliminated if a frame-based test-taking system is used. However, since the test-taker may still speak and try to communicate with a consultant, the sound-sensors or microphones 46, whether incorporated into the tablet computer and accessed via a cable connection or incorporated into another structure such as the frame itself, will still be beneficial.

Although the computer being used for test-taking does not require all of the accessories described in the embodiment above with reference to FIGS. 1-5, it can contain a camera or other imaging device and a biometric device, such as a fingerprint sensor. More generally, since the camera can be used for one biometric measurement, the computer can contain at least two systems that enable two biometric measurements 52, 54 to confirm the identity of the test-taker. These two biometric measurements may be obtained via the camera, e.g., a facial scan or an iris scan, and the finger print sensor or by any other combination of two or more biometric measurement devices or sensors. Among others, a palm scanner may be incorporated into the computer, or may be connected to the tower 20 and its processing unit 24 if present. Representation of biometric sensors 52, 54 apart from the processing unit 50 and the housing 44 and strap 42 does not imply that these must be separate therefrom and indeed, they may be arranged, as desired, on any of these components. Also, in some cases when the tower 20 is used, the processing unit 50 may be the same as the processing unit 24 arranged on the tower 20.

The facial scan obtained via a camera used as biometric sensor system 52 may be used to image the pattern of blood vessels in the test-taker's face, in which case, an infrared illuminator should also be used (not shown). The illuminator would be mounted on the support 22. The illuminator could also be used to aid in the facial recognition, if so desired.

Accordingly, one embodiment of a frame in accordance with the disclosure includes, in addition to the housing 44 with the screen and a strap 42, one or more microphones 46 or other sound sensors that sense sound in the vicinity of the frame. Of course, the test-taker might be talking to himself and this talking detected. However, the processor 50 associated with the frame could be configured to require the test-taker to speak to initiate the system and then compare any other subsequently detected sounds to the voice of the test-taker. Detection of a voice other than that of the test-taker would be a good indication of the test-taker cheating by receiving assistance from someone else. This problem is at least partially solved by requiring the test-taker to be quite when taking a test.

A particularly useful arrangement is to incorporate the microphones and RF sensors into the strap 42 or preferably into a device which at least partially covers each of the test-taker's ears as shown at 46, 48. Two microphones, one at each ear, can additionally locate the source of sound coming to the test-taker as lying in a plane perpendicular to a line passing through both microphones. If a third microphone is provided at the top of the test-taker's head, also 46, then the location of the source of a sound can be determined. This can be helpful in differentiating sound from a consultant from road noise in a city, for example. Similarly, the use of three RF sensors can pinpoint the source of the RF transmission and if that source is located on the body of the test-taker, then this becomes significant evidence that there is another device being worn by the test-taker which is communicating with a consultant. Such devices are available today to assist students in cheating on tests.

Another way for the test-taker to cheat while wearing the frame would be to type questions onto a smartphone or a second tablet or other type of computer, or provide this smartphone or computer with voice-recognition that converts the test-taker's speech into a communication. To prevent this type of cheating, the tower 20 or tablet computer being used for test-taking should be configured to detect communications. He or she might use another device to type in questions such as a smartphone hidden from the cameras.

More importantly, for the reasons described above, in order to guarantee that the biometric measurements have not been compromised, at least one of the measurements should be accomplished on a secure device which is CID protected and which contains the private key. Since the private key should be adjacent to the display which is on the frame, the biometrics measurement system also should be housed on the frame. If a camera is mounted on the frame so that it has a clear view of one of the test-taker's eyes, then an iris scan can be easily accomplished. Since the iris scan is among the most reliable of the biometric measurements, this may be sufficient. If a second biometric measurement is desired, then the same or different camera can perform a retinal scan or a scan of the blood vein pattern around the eye. Also a second camera can be provided to check the second eye. This eliminates the need for this hardware to be part of the computer or a tower. Now, any computer can be used by the test-taker for test taking. The test is decrypted just as it enters the display and the display can only be seen by the test-taker. The private key and test-taker's biometrics are stored in a CID-protected assembly on the frame adjacent to the display. Microphones are provided to detect any talking by the test-taker and a sound creator to test the microphones. Two problems remain which will be addressed below. A camera can be mounted within the frame which captures the images and transmits them to another room and the test taker can be typing messages to the consultant on the keyboard or other device.

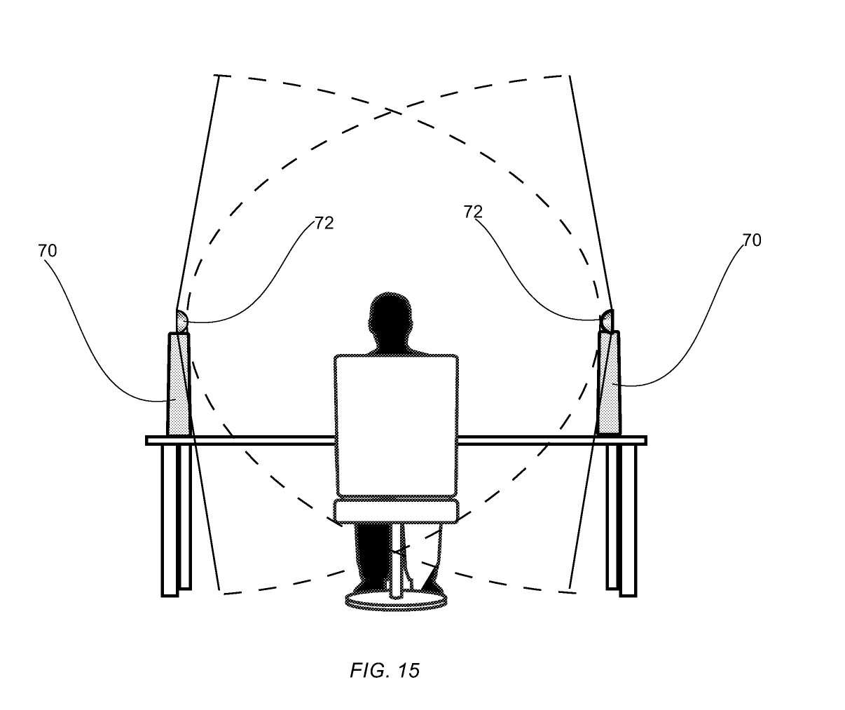

The foregoing reveals that while a test-taker's tablet computer could be used for secure test-taking, it must be CID-protected and configured to improve detection of possible cheating. Some tablet computers are dual-mode tablets that allow for a limited operating system, which limited operating system could be used for test-taking, whether solely for test-taking or for test-taking and other purposes. In such a limited operating system, Internet access is restricted, among other things. Such tablet computers would ordinarily include a camera and software capable of performing a photographic-based fingerprint and an iris scan (and/or facial vein pattern or retinal scans) to provide a biometric analysis to confirm the identity of the test-taker. As long as the tablet display is not seen by a consultant then this can be a good system. However, as discussed above, it is almost impossible to prevent the display from being observed. Also no tablets are on the market with CID-protection, so this will need to be an specially designed device. It has been proposed to attach this to the tower as shown in FIG. 13A.

A first configuration for an arrangement for secure test-taking using a dual-mode tablet computer therefore includes configuring the dual mode tablet computer 56 for use for test taking while having the limited operating system. The tower 20 is provided in a room or other area in the vicinity of the tablet computer 56, and the tower 20 is provided with the ultrasonic sensor array embodied by ultrasonics board 36, or comparable ultrasonic unit, and the camera 26, e.g., a spherical camera. In addition, a head-mounted frame is provided to the test-taker and includes one or more communication-detecting sensors 48 on the housing 44 and/or strap 42 and one or more sound-detecting sensors 46 on the housing 44 and/or strap (see FIG. 12). A fingerprint biometric sensor 52 is also provided, e.g., as an attachment to the tablet computer 56 or connected to the processing unit 50. Finally, a biometric sensor 54 capable of detecting and analyzing an iris scan (and/or facial vein pattern or retinal) to provide a biometric analysis to confirm the identity of the test-taker is also included. This may be an attachment of the tablet computer 56 or an attachment to the processing unit 50 which is inside of tower 20.

Advantages of this configuration include the limited required modification, if any, to the tablet computer 56 of the test-taker (since the hardware can be implemented in the tower 20 or connected by cable of the tower 20), and the relatively low cost. Also, the equipment to construct the tower 20 is readily available. Disadvantages include the difficulty in monitoring the test taker's peripheral vision and the ability for a consultant to view the display of the tablet computer 56.

A second configuration involves use of a more specialized frame worn by the test taker, such as the headgear referred to as the Oculus Rift™. This headgear is significantly more complicated and expensive relative to the simple frame including the communication-detecting and sound-detecting sensor(s) in the first configuration. Yet, the Oculus Rift™ could be modified, if necessary, to include one or more communication-detecting sensors 48, if desired, and one or more sound detecting sensors 46. The communication-detecting sensors 48, as well as any other communication detecting sensors or systems disclosed herein, may be radio frequency communication detecting sensors or systems The tower 20 can also be used in this embodiment with the ultrasonics capability and camera 26. The fingerprint biometric sensor can be used as well. Finally, either the iris scan sensor is used before the Oculus Rift™ is put on, or a separate biometric sensor is used to validate the identity of the test-taker, e.g., a voice print, typing pattern, palm scan, and face recognition-based system.

Advantages of this configuration include the ability to combine it with gaming hardware (the primary development purpose of the Oculus Rift™), thereby reducing combined system cost and increasing market potential, the inability for a consultant to the test-taker to view the display (which is inherently only visible to the test-taker wearing the Oculus Rift™), visual input from the consultant is effectively eliminated and a tower 20 is optional. Disadvantages include the fact that the Oculus Rift™ is currently expensive, touch typing skill is required for textual input and some students will experience nausea from use of the Oculus Rift™. Another product with similar properties is The Vuziex Wrap 1200 video eyewear as described at http://www.vuzix.com/consumer/products_wrap_{—}1200/.

Yet another configuration includes a Google Glass™ type display. In this case, the frame worn by the test-taker is Google Glass™ which can be equipped with one or more radio frequency communication-detecting sensors 48, if desired, and one or more sound-detecting sensors 46.

Advantages of this configuration include the fact that a consultant cannot view the display as only the wearer of Google Glass™ can see the display, the frame has other uses than just test-taking (any other uses for Google Glass™) and thus reducing system cost and increasing market potential, eye tracking is available to control student's peripheral vision, gesture input can be an option for answering questions on the test being taken, and a tower is optional. A disadvantage is that Google Glass™ is currently expensive.

Yet another configuration is possible in which the strap 42 and/or housing 44 include a total of four cameras with fish eye lens or comparable lens that are positioned to provide the same field of view as the cameras 26 mounted on the tower 20. In this case, again, the tower 20 can either be eliminated or its components reduced since the optical imaging hardware is now provided on the head-mounted apparatus of the test-taker.

Let us now consider in detail some of the components of the invention and variations thereof. FIG. 13A illustrates the use of the tower 20 to hold and position a tablet and to serve as a docking station for the tablet 56. The tablet 56 when inserted into the holding ledge 52 automatically connects a USB hub to the micro USB port on the tablet. This hub is used for attaching a cable from the goggles or glasses, a mouse and a keyboard if provided.

Although the spherical camera is shown as comprising two imagers and lenses, an alternate approach is to provide a linear array which rotates in order to capture the spherical image. Whichever camera is used, it can be vertically positioned using a small motor which moves the camera vertically upward and downward in order to provide the optimum camera location.

FIG. 13B illustrates an alternate approach where the tablet 50 is placed on a table 54 and connected by a wire to the tower 20.

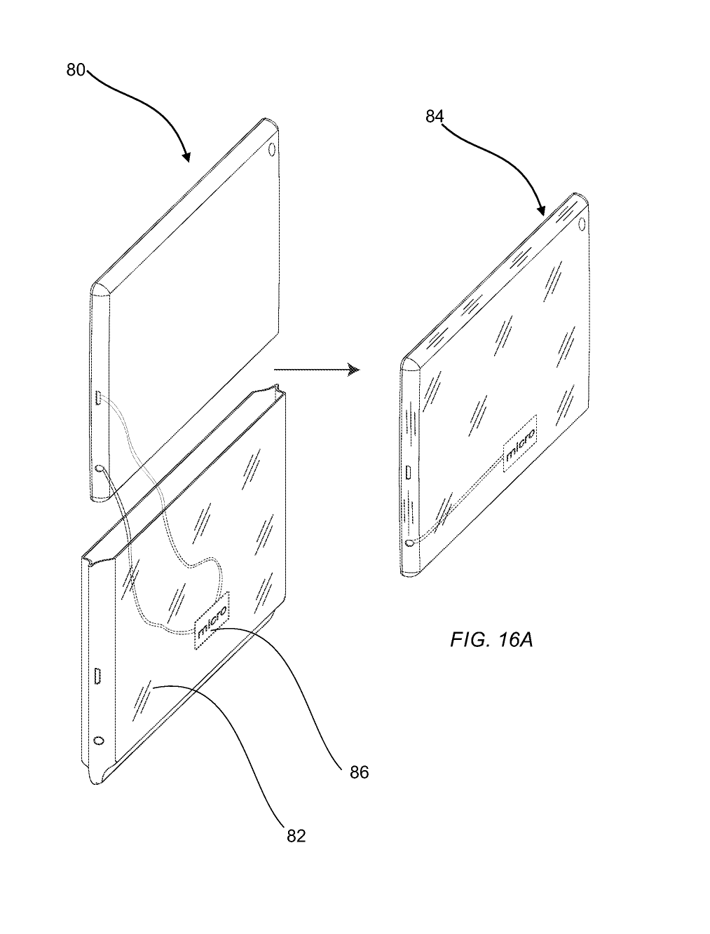

FIG. 14 illustrates the use of a Google Glass™ type device 60 in place of the Oculus Rift™ device of FIG. 12. The Google Glass™ device 60 contains a head camera 62 as described elsewhere. One problem with the Oculus Rift™ implementation is that it would be relatively easy to mount a camera and transmitter inside the housing 44 which could view the display and transmit its contents to a remote location. This would be quite difficult with the Google Glass™ implementation. On the other hand, the monitoring of the environment in the room becomes more important in the event that the consultant has somehow gained access to the contents of the test and is displaying answers on the floor or ceiling, for example. The microphones and RF sensors are shown here as 64 and 65 respectively.

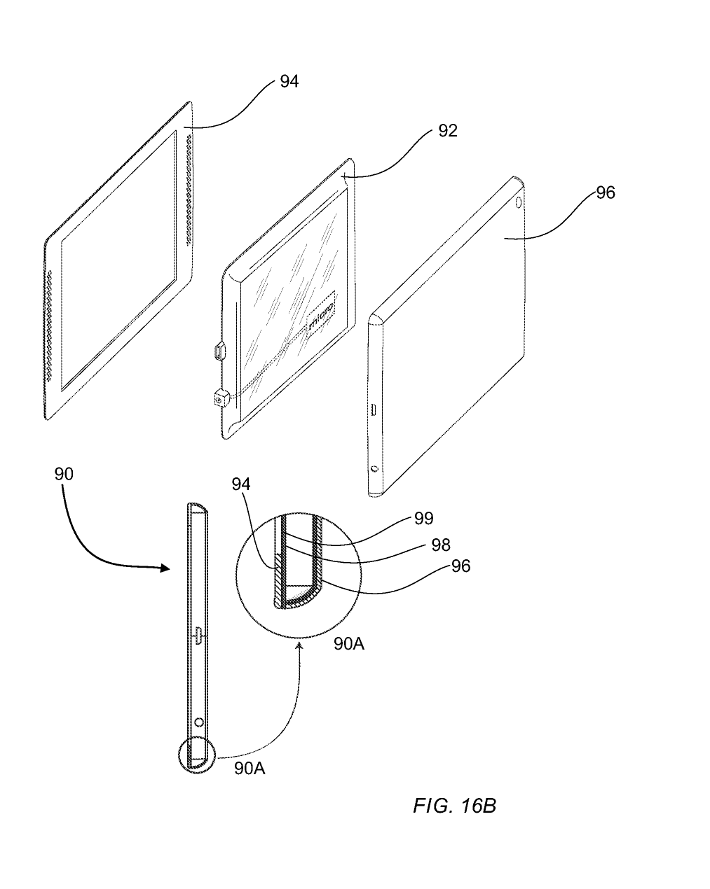

When a spherical camera comprises two hemispherical cameras, there is likely to be a dead spot in line with the joints between the two cameras. Although this can be made quite small, nevertheless, sometimes it is desirable to eliminate this completely. This can be accomplished as shown in FIG. 15 by displacing the two hemispherical cameras, 72, horizontally as shown in the drawing. They are showing mounted on towers 70. Naturally these cameras can be displaced vertically or in any other configuration that is easy to implement and which provides the best view of the room and test taker.

If the room is dark, it is conceivable that a consultant can be positioned in the room in such a manner that his presence is not detected by the spherical camera. In such a case, the consultant might be positioned in such a location that he or she has a view of the display. In order to prevent the camera from not seeing the consultant in this situation, a small amount of illumination may be provided in conjunction with the spherical camera. This illumination can be in the visual spectrum or, more likely, in the near IR portion of the spectrum. It is expected that if the consultant moves, his presence will be detectable by the ultrasonic motion detector, however if the consultant is very still, this might not occur. Another approach is to provide imagers with long wave IR sensing capability, in which case, the presence of an object whose temperature is above that of ambient can be detected. This system can be defeated when the environment is at a temperature which is at or slightly higher than the temperature of the human body.

Thermal IR motion sensors could of course be used as an alternative to the ultrasonic sensors described above. Such sensors can be fooled by strong sunlight heating a surface in the room, a cup of coffee, and, as mentioned above, when the ambient temperature approaches body temperature. Ultrasonic motion sensors provide an easier method of locating the source of motion in a room, estimating its size, and permitting pattern recognition systems to identify the object causing the motion. Although these can also be accomplished with thermal IR sensors, the cost and complexity is considerably higher.

A further solution is to require that the room where the test is being taken have adequate lighting. Even it that case, there may be areas which are shaded from the light.

Consider now the camera which is worn by the test-taker 62. This camera can be designed to snap on to any appropriate glasses frame allowing the student which normally wears glasses to apply the camera to his or her glasses frame. The head camera typically will have a field of view which is substantially less than the field of view which the student can see by moving his eyes to one side or the other or up or down. Thus, the student may be able to observe signals which are not seen by the head camera. This requires that the head camera be designed to have a wide field of view and may also require that the glasses worn by the students contain shades which prevent the student from observing areas which exceed the field of view of the head camera. The tablet-mounted camera can be used to ascertain that the student is properly wearing his or her glasses so as to prevent momentary displacement of the glasses and head camera to allow for a temporary peripheral glance by the student.

As mentioned above, the glasses containing the head camera can also contain RF sensors 65 and microphones 64. Normally, two RF sensors and two microphones will be used; however, if it is desirable to locate the direction of a source of sound or radio frequency, then a third microphone and a third RF sensor can be provided at a convenient locations such as on top of the headset, as discussed above, of the student but connected to the glasses where the other sensors are located. By triangulation, therefore, the source of either sound or radio frequency at a particular sensed frequency can be located. The sound, for example, may be coming from immediately behind the student where a consultant has positioned himself in such a way as to not be observable by the cameras and yet still have the ability to see the display and therefore to help the student with the correct answer. Similarly, the RF source may reside on the student's body as used in a commercially available cheating system. All of the devices which make up a headset can be multiplexed into a single USB cable which then can be plugged in to the tower as provided.

Previously, secure test taking apparatus employing an inexpensive tablet have not been available. What follows will now discuss a preferred embodiment of such a secure tablet. A tablet geometry has advantages over alternates such as a desktop or laptop computer as will become evident.

A fingerprint sensor may or may not part of the tablet and thus a separate fingerprint sensor peripheral may be required as a first biometric device. If the second biometric device is an iris scanner, face recognition scanner, hand geometry scanner, or other system utilizing a camera, the tablet resident web camera may be sufficient for any of these biometric information gathering purposes. For example, the student may be requested to place his iris within 3 inches of the tablet resident camera for the purpose of obtaining an iris or retinal scan or hold his hand 6 to 8 inches from the camera.

The fingerprint scanner may be a conventional system where the student swipes his finger across an aperture and the number and spacing of the ridges in the scanned area are recorded and processed typically by counting the ridges. This has been found to be relatively easy to fool by using a picture of a fingerprint, for example, or by merely trying a large number different fingerprint pictures. Also, if access to the computer can be obtained the recorded fingerprint can be hacked or the fingerprint can be obtained when the student allows it to be measured by another computer and then a photograph produced and used in the testing computer. If access to the internal circuitry of the computer is permitted or even just to the fingerprint scanner, then a previously recorded signal reprehensive of the student can be substituted for the actual scan.

An alternate and preferred design makes use of the tablet rear camera and the student places his or her finger at a directed position and the finger is photographed. This theoretically could also be fooled by the use of a picture so the finger can be monitored over a few seconds to determine that a pulse is present using methods such as amplifying the motion or the color of the finger as disclosed in: “Software Detects Motion that the Human Eye Can't See”, Conor Myhrvold, MIT Technology Review, Jul. 24, 2012; “Seeing the human pulse”, Larry Hardesty, MIT News Office, Jun. 19, 2013; and, “Guha Balakrishnan, Fredo Durand, John Guttag, Detecting Pulse from Head Motions in Video, presented at the IEEE Computer Vision and Pattern Recognition conference, 2013. More of the finger print can be captured by this method making it more accurate and difficult to fool than the fingerprint scanner. Also multiple fingerprints can be simultaneously acquired.

Due to the high stakes involved in the granting of degrees by prestigious universities, it can be expected that attempts will be made to alter the tablet so as to permit information which normally resides only within the tablet to be transferred elsewhere. This will require breaching the chassis of the tablet. Several chassis intrusion sensors have been developed such as a light sensing sensor which records an incident if the cover of the tablet has been removed and any light is present, or a mechanical switch or other electrical connection that is disrupted upon removal of the tablet back. Although in some cases, these chassis intrusion sensor will be difficult to defeat, in all cases a conventional chassis intrusion sensor can be defeated. For example, if a light sensor is used then the cheater can buy one laptop and locate the light sensor and then in a second laptop he can remove the cover in a dark room and place tape or spray black paint over the light sensor thereby defeating it.

The first and easiest step in preventing chassis intrusion is to replace the screws, when screws are used to attach the back, with fasteners which cannot be readily removed. This can be done in the case of screws by removing the present screws and replacing them with screws that when screwed in and a threshold torque is obtained, then the screw breaks off of the driving shaft. Secondly, a tape can be securely attached to the joint between the cover and the remainder of the tablet with an adhesive such that the tape must be broken in order to remove the cover. If the tape has encoded within the tape a complicated code which can be read by the tablet and if this code cannot be read or otherwise hacked and is destroyed during the removal of the tape, then intrusion by cover removal can be detected and thus prevented. There still remains the possibility of slicing through the cover without moving the screws or disturbing the tape. In this extreme intrusion method, therefore, the entire back of the tablet can be covered with a film which contains a distributed code in such a way that the breach of any portion of the film alters the code and can be detected by the tablet.

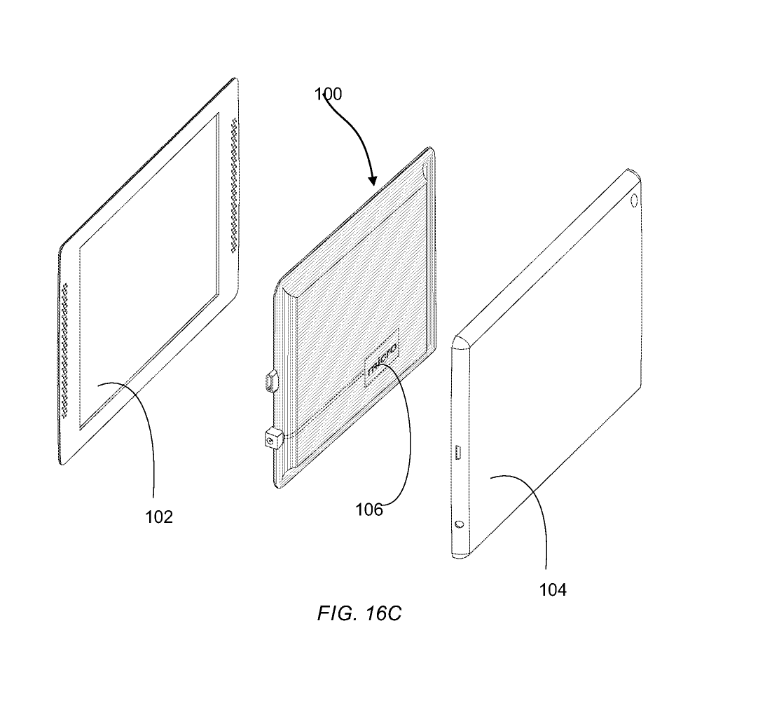

Another such area wide chassis intrusion detector (CID) device is depicted in FIG. 16A which illustrates a film which contains two closely spaced conductive films. The capacitance between these films is measured and monitored by the tablet. If any attempt is made to breach this film, it is likely that one of the conductive layers will be shorted to the other which even if it happens momentarily, can be detected. If one of the films is carefully removed, which would be extremely difficult, then again the capacitance between the two films would be detectably altered. The two films can reside within a thicker plastic assembly such that damage to the films through normal handling of the laptop would not be likely to occur.

A key complement of the chassis intrusion detection systems described below is the use of a small microprocessor and RAM assembly along with a small battery. The battery is connected to the microprocessor through small diameter wires. This assembly is potted such that any attempt to disassemble the assembly will break one or more of the wires connecting the battery to the microprocessor. The microprocessor interrogates the capacitance of the intrusion protection film such as once per second. The battery has sufficient stored energy to power the microprocessor for a long period such as 10 years. The assembly can also be connected to the laptop battery which would then maintain the 10 year battery fully charged. If the volatile RAM loses power, which can happen either through a command from the microprocessor if the capacitance of the film has changed or if the ten-year battery has been disconnected, the contents of the RAM memory will be erased. This RAM memory upon construction of the laptop for test taking purposes would contain the private key associated with that laptop.

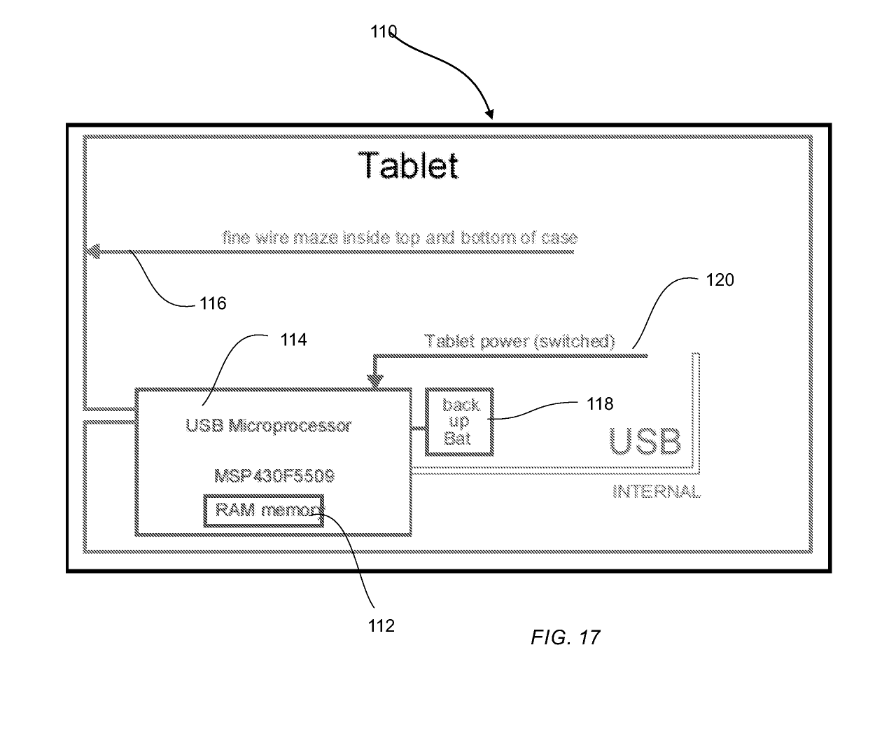

Starting with a standard off-the-shelf tablet computer such as the Tegra note. http://www.newegg.com/Product/Product.aspx?Item=N82E16834099001, the RAM, microprocessor and battery assembly is built into a small assembly hereinafter call the security assembly (SA) as shown at 114 in FIG. 17, which plugs in to one of the available ports such that it can be accessed by the tablet CPU. This assembly is also inside of a film envelope and connected to the leads of the conductive layers of the film. Assembly of this system to the tablet is as follows, as illustrated in FIG. 16A:

1. Place the tablet inside the envelope and plug in the SA.

2. Fold over the flap of the envelope and make sure that power and micro USB ports are adjacent an opening in the envelope provided for that purpose.

3. Activate the SA using available wires to load the private key and burn the fuse links.

4. Fold over the envelope flap so that it overlaps with a portion of the rest of the envelope.

5. Apply heat to shrink the envelope around the tablet.

The final assembly can therefore be totally encapsulated with the film and the only openings to the outside world would be the power and micro USB ports provided. Some care should be exercised to make sure that these ports cannot be compromised. Special operating system software can be loaded and designed so that it cannot be compromised. The key to this system is to have a film which is transparent so that it does not interfere with viewing the screen. This can be eventually done using graphene but for now indium tin oxide can be used to form the conductive film layers. http://en.wikipedia.org/wiki/Transparent conducting film.

In FIG. 16A, the tablet computer prior to assembly of the encapsulating film is shown at 80. The two layer conductive film is embedded in the plastic film envelope 82. The SA is depicted at 86. In reality, the SA will be quite small such as occupying a volume of 10 mm³ or less. The final assembly is depicted at 84.

FIG. 16B illustrates the back cover 96, the motherboard and display assembly 92 and the front cover 94 of a standard off-the-shelf tablet computer as illustrated in FIG. 16A. In this case, the SA is packaged with the tablet cover but inside of the CID film. The film is glued to the entire back cover of the tablet and extends slightly outside of the area of the cover as depicted at 90 and in more detail at 90A. The SA is attached to the film and plugs into the motherboard. When the cover is attached to the remainder of the tablet, it is firmly glued or heat sealed in place so that once attached, the cover cannot be removed from the remainder of the tablet without destroying the cover as shown at 96. The film is arranged so that it is also glued to the interface and partially to the area above the interface. Thus any attempt to breach the tablet will damage the film. In FIG. 16B, the glue is depicted at 99.

In both FIGS. 16A and 16B, the film contains two layers of conductive film arranged in close proximity to each other with approximately a spacing of 0.001 inches and covered by a thicker plastic film of approximately 0.02 inches on each side resulting in a total thickness of approximately 0.043 inches. An alternate construction is to use a pattern of small conductive wires which can, for example, be 0.005 inches wide with a similar spacing between the wires as shown in FIG. 16C. In FIG. 16C, the front cover is depicted at 102 the interior circuitry at 100, the SA at 106 and the back cover at 104. Typically these wires will appear in pairs and will meander throughout the film. The SA will be connected to the ends of these wires and continuously monitor their resistance and mutual inductance. If there is any change in the geometry of these wires in the mash after assembly of the cover to the tablet, then this will be sensed by the SA and the RAM memory will be erased thereby destroying the private key. The mesh of wires depicted in FIG. 16C can be economically produced by xerographic techniques resulting in a very low cost chassis intrusion detector system.

To summarize, any disruption of the mash or conductive film in either of the above described examples will destroy the private key making it impossible to decode the test questions. After the assembly is completed, the computer can be powered on and the first step would be to measure the inductance, resistance, and capacitance of the mash or films. Thereafter, if any of these measurements significantly change, then the circuit in the SA would remove power from the RAM thereby destroying the private key. Since the private key cannot be reloaded, the assembly would need to be returned to the factory for remanufacture.

The electronic circuit which powers the CID system of FIG. 16 is illustrated in FIG. 17. An embedded microprocessor is powered by a 10 year battery and contains a RAM memory. The RAM memory contains the private key encryption code needed to decrypt the test questions. The microprocessor continuously monitors the wires on the CID and if there is any change in the resistance, mutual inductance or capacitance in the circuit, the microprocessor disconnects power from the RAM and the private key is erased.

FIG. 17 is a schematic of the system of FIG. 16C shown generally at 110. Power is supplied from the tablet at 120, the fine wire maze at 116, the SA at 114 the long life battery at 118 and the RAM memory at 112.

A determined cheater still has one route open for getting the assistance of a consultant. Since the tablet display can be observed optically, a consultant may position a camera with a telephoto lens somewhere in the room or on or through a wall that can view the tablet screen. Alternatively, the student may wear a hidden camera, which is not observable by either the spherical camera or the tablet Web camera, which can monitor the tablet display. Such a camera, for example, may be worn around the neck of the student and view the screen through a very small opening in the shirt or blouse worn by the student. These two types of cameras can be disguised in such a manner that it is virtually impossible for the system monitoring cameras to detect their presence. Nevertheless, either of these cameras can transmit the contents of the tablet screen to a consultant in another room, for example. A solution to this final problem rests in scrambling the display and providing the student with a special pair of glasses which descrambles the display. Many techniques are available for accomplishing this task and one will now be explained.

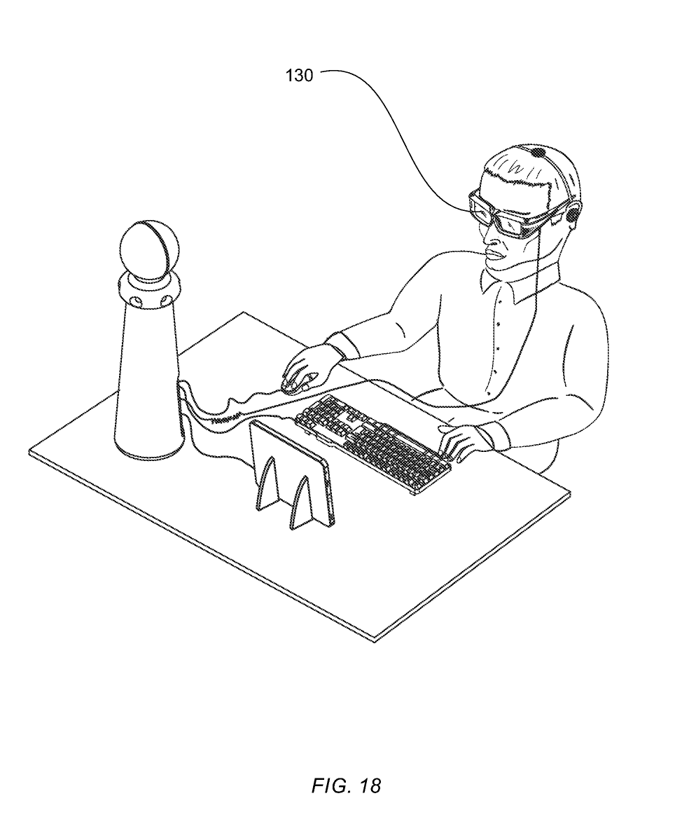

Modern displays refresh the screen at 240 Hz. Since the text on a test changes very slowly only a small portion of this information need be seen by the student. For example, if the screen displays constantly changing images which are very similar to the text on the test wherein only 5%, for example, of the images represent the actual test, then anyone observing the screen through one of the aforementioned cameras would see a blur of constantly changing text. If the student wears a set of glasses illustrated at 130 in FIG. 18 where the lenses are made opaque through liquid crystal technology, then the lenses can be made transparent only during the 5% of the time that the display presents the actual test questions. Such glasses are commercially available consumer products which are used for 3-D television viewing. For an example of such glasses see http://www.dimensionaloptics.com/Panasonic.aspx. The particular frames that contain the actual test questions can be randomized and the random code indicating which frames are to be seen can be sent to the glasses control module in an encrypted form, also protected with a CID system, such that only the glasses worn by the student know which frames to view.

If the hidden camera image capture apparatus used by the consultant is sufficiently sophisticated, each frame could theoretically be captured and thus the consultant could see all of the frames and if it was obvious which frames contained the actual test questions than the consultant could discard all the irrelevant images. It is therefore important that there be no obvious clue as to which images contain the actual test questions and remaining images must look very similar with only slight differences.

FIG. 18 illustrates the glasses worn by the student, shown at 130, allowing the student only to see the test questions. These glasses are designed to fit over prescription glasses and can be part of the headset which contains the microphones, head camera and RF sensors.

Goggles such as those produced by Oculus Rift™ can be used to provide a measure of secure test taking but they can by defeated if a small camera is positioned either through attachment to the inside of the goggles or through attaching via adhesive, for example, to the face of the viewer. This camera could then watch display on the Oculus Rift™ goggles and broadcast that display to a consultant. If the tower and spherical camera are not present, then the consultant could easily reside within the test taking room to offer assistance to the student. Other methods of capturing the display information are also possible involving splicing additional wires into the Oculus Rift™ hardware. This can be counter-measured through the CID. However, to detect all possible methods of extracting display data from the Oculus Rift™ goggles or equivalent is possible, but can be a daunting task.

The use of display glasses such as Google Glass™ is somewhat more difficult to hack and therefore more secure. The tablet camera, for example, can monitor the face of the student to determine that there are no hidden imagers watching the display. There still remains the possibility of capturing information in the wires to the display but through placing a microprocessor within the display and feeding only encrypted display information through the wires, the chance of this happening is minimized. The disadvantage of the display glasses rests in the fact that the student can still see potential information sources that would be unavailable to the goggles wearer.

Another approach replaces the tablet with a tower which contains the central processor normally resident in a tablet. This tower does not have a display and can be built as a totally sealed unit which cannot be opened without destroying the tower housing. Various methods of detecting housing breach using a CID system as discussed above can be implemented more easily with such a tower than with a laptop or tablet which is designed to be serviced. This can be a relatively secure system and it can interface with a tablet, goggles or display glasses as desired.

It is expected that the process of teaching using the Internet and testing using the concepts herein involves some monitoring of the test-taker including feedback from the test-taker. Also, pattern recognition analysis can be employed more and more to understand the particular students understanding of the course being taught. Eventually, this could result in the elimination of quizzes and tests and the feedback of the progress of the student through the course will lead to an accurate assessment of the degree to which the student has mastered the subject matter. The degree to which the student is motivated to master the subject matter ought to be detectable and thus his success in such mastery also detectable even without the use of the testing system described.

Some important features of this invention differentiate it significantly from prior art attempts to develop secure testing systems. These include:

1. Control over the ports of the computer through a secure operating system to prevent the attachment of devices which can support the transfer of information out of the computer to a nearby or remote site which can thereby capture the information displayed on the monitor. This control is done through the operating system when the computer is operating in a secure mold which is different from the standard operating system.

2. The use of a spherical camera which allows monitoring of the entire space surrounding the student to detect the presence of helpers or of changing text which can be used to transmit information to the student.

3. The ability to detect the existence of a consultant who would be out of the view of the typical camera which is present in a laptop or tablet. This is done through an array of one or more ultrasonic motion detectors, a variety of cameras and illumination where necessary.

4. The use of strong encryption coupled with the protection of the private key which cannot be extracted from the computer thus requiring that the student use a particular computer for taking tests.

5. The use of a chassis intrusion detection (CID) sensor or system which renders the physical breach of the computer chassis virtually impossible without destroying the private key needed for test decryption.

6. The detection of sound adjacent the ears of the student such that anything that can be detected by the student's hearing can also be detected by the microphones.

7. The placement of RF sensors adjacent the student's ears such that any RF communication to the student and in particular to an earpiece which the student may be wearing can be detected. This defeats a common system used in China for cheating on tests.

8. Visual cues from a consultant which may be displayed out of the view of a standard tablet or laptop camera are detected by the spherical camera system and by the head camera disclosed herein. In particular, the existence of notes, a hidden tablet, or smart phone which the student can view will also be detected by the system of this invention.

9. The location of audio and RF signal sources at known frequencies can be determined to indicate whether those locations are within the room occupied by the student.

10. The detection, for example, of a smart watch or other similar apparatus which can be hidden from view of a tablet or even the spherical camera but can be detected by the head camera.

11. The use of sophisticated neural network based pattern recognition algorithms which allow for continuous improvement of this system as new cheating methods are discovered. This allows for upgrading the software of the system as new improvements are implemented. These neural network systems initially will be used for detecting changing static patterns such as displayed text on a surface such as the ceiling of the room, but the capability exists for adding the detection of suspicious behaviors on the part of the test taking student.

12. The use of a scrambled display and light valve glasses to permit the contents of the display to be only observed by the student and not capable of being captured in a meaningful way by a camera having a view of the display.

Disclosed herein are a series of measures that are designed to prevent the transfer of test related information to anyone other than the test taking student by any means either visually, electronically, or wirelessly. The measures disclosed herein are not exhaustive and the intent of this invention is to cover preferred implementations of such techniques. Similarly, disclosed herein are a series of measures to prevent information from being transmitted to the test taking student on the assumption that the information about the test has leaked to a consultant. Since the consultant now must transmit to the student information which will affect how the student answers the question, this invention has also not exhaustively disclosed all possibilities of information transferal from the consultant but only representative cases. It is not the intent of the inventor to cover all such transferal means including, for example, haptic methods which have not been discussed above. These include, for example, a wire attached to the student and physically held by the consultant who may in fact be located in another room wherein the wire travels through a hole in a wall. In this case, for example, if the consultant knows the test question and has determined that the proper answer is three then the consultant could pull three times on the wire thereby transmitting this information to the student. All sorts of similar haptic techniques exist including electrically actuated vibrators, spark creators etc. To cover all such possibilities of either the leaks of information out of the test taking device or the communication of information to the student would require volumes. Thus, it is the intent of the inventor to cover all such possibilities while disclosing those that are most readily implemented.

Finally, all patents, patent application publications and non-patent material identified above are incorporated by reference herein. The features disclosed in this material may be used in the invention to the extent possible.

1. A headpiece, comprising:
a frame having a support portion adapted to be supported on a person's head and a viewable portion adapted to present visual data to the person when said support portion is supported on the person's head;
at least one imaging device arranged on said frame to obtain images of an environment around the person when said support portion is supported on the person's head;
at least one user interface arranged on said frame to receive input from the person when said support portion is supported on the person's head;
a processor arranged on said frame and coupled to said at least one user interface and said viewable portion, said processor being configured to control content of said viewable portion based on input received via said at least one user interface; and
at least one communication-detecting sensor that detects communications,
said processor being configured to monitor detection of communications detected by said at least one communication-detecting sensor and images obtained by said at least one imaging device when said viewable portion is displaying a test to determine whether a person other than the person on which said support portion is supported is present or providing information to the person on which said support portion is supported.

2. The headpiece of claim 1, wherein said at least one user interface comprises a sound-detecting sensor, said processor being configured to monitor detection of sound by said sound-detecting sensor when said viewable portion is displaying a test.

3. The headpiece of claim 2, wherein said sound-detecting sensor is arranged on said frame.

4. The headpiece of claim 2, further comprising a strap adapted to extend over the person's head when said support portion is supported by the person, said sound-detecting sensor being arranged on said strap.

5. The headpiece of claim 1, further comprising a strap adapted to extend over the person's head when said support portion is supported by the person.

6. The headpiece of claim 5, wherein said at least one communications detecting sensor is arranged on said strap.

7. The headpiece of claim 1, wherein said at least one communications detecting sensor is arranged on said frame.

8. A method for detecting an attempt to physically alter an electronic device, comprising:
enclosing the device within two closely spaced conductive films overlying one another;
periodically measuring capacitance between the films by means of a security assembly coupled to the films; and
monitoring the measured capacitance by means of the security assembly to determine changes in capacitance, changes in capacitance being correlated to an attempt to alter the device.

9. The method of claim 8, wherein the security assembly includes a processor, power source for providing power to the processor and a RAM assembly containing a required security code for use of the device for test-taking purposes, the security assembly being configured such that any attempt to disassemble the security assembly will break one or more wires connecting the power source to the processor and such that a change in capacitance relative to a threshold will cause the security code to be erased from the RAM assembly.

10. The method of claim 8, further comprising coupling the security assembly to the device using a port of the device and with the security assembly within the films.

11. The method of claim 8, further comprising providing for apertures in an envelope defined by the films in which the device is placed, the apertures having a size and location aligning with power of USB ports of the device.

12. The method of claim 8, wherein the films are transparent at portions that overlies a display of the device.

13. An intrusion-protected electronic device, comprising:
an envelope defined by two closely spaced conductive films overlying one another that enclose the device; and
a security assembly coupled to said films and that periodically measures capacitance between said films, said security assembly being configured to monitor the measured capacitance to determine changes in capacitance, changes in capacitance being correlated to an attempt to alter the device.

14. The device of claim 13, wherein said security assembly includes a processor, a power source for providing power to the processor and a RAM assembly containing a required security code for use of the device for test-taking purposes, said security assembly being configured such that any attempt to disassemble said security assembly will break one or more wires connecting the power source to said processor and such that a change in capacitance relative to a threshold will cause the security code to be erased from said RAM assembly.

15. The device of claim 13, wherein said envelope includes apertures having a size and location aligning with power of USB ports of the device.

16. The device of claim 13, wherein said films are transparent at portions that overlies a display of the device.

17. A method for limiting viewing of content on a display, comprising:
changing images being displayed on the display at a high rate at which viewing the display does not provide a discernible image to a viewer;
equipping a person with a viewing device having lenses that are selectively opaque or transparent; and
controlling the lenses to cause the lenses to be transparent only when determined content is being displayed on the display to enable only a lenses-equipped person to correctly view the predetermined content.

18. The method of claim 17, wherein the predetermined content is a test.

19. The method of claim 17, further comprising randomizing the image frames containing the predetermined content and providing an indication of the randomization only to the viewing device.

20. The method of claim 17, wherein the viewing device incorporates a chassis intrusion detection system.
